(19) United States
(12) Patent Application Publication
(10) Pub. No.: US 2012/0241391 A1
(43) Pub. Date: Sep. 27, 2012

(54) FILTRATION ARTICLE WITH MICROBIAL REMOVAL, MICRO-BIOCIDAL, OR STATIC GROWTH CAPABILITY

(75) Inventors: Robert E. Carlson, Minnetonka, MN (US); Karen Schlichtmann Schmidt, Chaska, MN (US); Robert M. Carlson, Duluth, MN (US)

(73) Assignee: RECEPTORS LLC, Chaska, MN (US)

(21) Appl. No.: 13/428,423

(22) Filed: Mar. 23, 2012

Related U.S. Application Data
(60) Provisional application No. 61/467,604, filed on Mar. 25, 2011.

(51) Int. Cl. B01D 39/16; B01D 39/14; B01D 39/18; B01D 29/05; B01D 61/28; B01D 37/00; C02F 1/00; B01D 46/00; B01D 39/00; B01D 71/60; C02F 103/08

(52) U.S. Cl. 210/808; 210/506; 210/508; 210/483; 210/499; 210/498; 210/416.1; 210/500.37; 210/500.21; 210/767; 55/524; 55/467; 55/385.2; 55/368; 95/285

(57) ABSTRACT

Disclosed are filter media constituents, filter media, filter constructions, and methods of employing the filter media and filter constructions for fluid filtration. The filter media and filter media constituents of the invention have unique properties enabling the efficient capture of microbes or microbial generating units. Fluids usefully filtered using the filter media and filter constructions include air and water.

### CROSS REFERENCE TO RELATED APPLICATIONS

This application claims priority to U.S. Provisional Patent Application No. 61/467,604, filed Mar. 25, 2011, the contents of which are herein incorporated by reference in their entirety.

### FIELD OF THE INVENTION

The invention relates to microbial control with a filter based product that can be in the form of a mass of fiber, bat, or wipe often in the form of a nonwoven.

### BACKGROUND

Microbial contamination can be the cause of problems in many fields of activity. Unwanted microbial populations can be a health hazard, cause problems in pharmaceutical and food production and in general can cause waste due to the harmful effects of such bioactive materials on sensitive compositions and materials. Many fluids, including liquids and gases, contain undesirable microbial residue of sufficiently high numbers to contaminate a sensitive product or process. Fluids such as air and water, and body secretions such as mucus can contain sufficient microbe content to cause humans or animals to become sick when exposed to the fluid or bodily secretion.

Filtration is most commonly the mechanical or physical operation which is used for the separation of solids from fluids (liquids or gases) by interposing a medium through which principally only the fluid can pass. Filtration is also used to describe the process by which undesirable constituents are removed by adsorption into or onto the filter medium.

Filtration media, such as thick nonwoven mats or thin, paperlike nonwoven sheets, porous or nonporous particles or beads, porous membranes, column packing materials, and the like have been used to obtain microbial removal characteristics where microbes are undesirably present in a fluid. For example, face masks, air filters, furnace filters, water filters, various medical drapes and barriers, and the like have been used to retain microbes while allowing the fluid to pass through the filter in either active or passive filtration. However, many such filtration technologies rely on the filter media's average fiber-to-fiber distance, or (in membrane type filters) pore sizes, that are smaller than the average microbe size to strain the microbes from the fluid as the fluid traverses the filter media. Because bacteria generally range in size from 0.2-2 microns in diameter, and in many cases are less than 1.5 microns in diameter, only very small effective pore sizes are useful in the physical filtration of bacteria. Viruses are typically even smaller, while fungi are somewhat larger, for example up to about 5 microns. Such small pore sizes as would be required to physically filter microbes are limiting as to the volume of fluid per unit of time that can traverse the filter without exhibiting a substantial pressure drop across the media; further, in some cases physical barrier filters are quickly clogged as an increasing number of microbes (and potentially other materials or contaminants) are retained on the surface of or within the thickness of a filtration medium.

Filtration media having electrets, or dielectric materials exhibiting an external electric field in the absence of an applied field, have been developed. Using such filtration media, the physical capture of microbes is enhanced in gaseous filtration by electrostatic interactions. Thus, capture of microbes is not dependent solely on physical straining; structurally, more “open” filter media can be used, resulting in lower pressure drop across the media and higher volume throughput possible. However, electrostatically charged filter media are only useful with gaseous filtration operations. Further, such capture mechanisms are not specific to microbes but are generally employed to filter particulates from a lightly loaded air stream; thus, such filter media are most often used in HVAC applications.

Affinity chromatography is a specialized type of filtration that exploits the specific binding of antibody to antigen held on a solid matrix, wherein an antigen is bound covalently to chemically reactive beads. The beads are loaded into a column, and the antiserum is passed over the beads. The specific antibodies bind (typically in reversible fashion) to the antigen, while all the other proteins in the serum, including the antibodies to other substances, are eluted through the column. Thus, affinity type processes separate or remove biological entities from a liquid based on affinity rather than size.

All of the filtration types noted above have useful attributes. Nonetheless, a substantial need exists for fluid filtration media that have substantially improved microbial capture, microbial micro-biocidal, or microbial static growth characteristics. A substantial need exists to provide these characteristics in a filtration article or system that further provides high volume throughput of fluid and low pressure drop across the media, and which avoids the problem of filter clogging. A substantial need exists to apply these filtration characteristics to both gas and liquid filtration applications and methods.

### SUMMARY

The invention relates to filter media constituents, filter media, filter constructions made from the filter media, and methods of employing the filter media for fluid filtration. The filter media and filter media constituents of the invention have unique properties enabling the efficient capture of microbes or microbial generating units. In embodiments, the filter media of the invention render microbes substantially innocuous through micro-biocidal or static growth properties. The filter media of the invention have defined fiber, membrane, particulate, or surface characteristics and unique capture chemistry whereby microbes are captured and bound to one or more surfaces present on one or more surfaces of the filter media.

The filter media of the invention have chemical functionality present on one or more surfaces thereof that are capable of trapping, immobilizing, adsorbing or absorbing a microbial organism onto or into the media from a mobile fluid. The organism is thereby removed from the fluid in sufficient numbers to reduce the infective nature of the fluid. In one embodiment the filtration media includes a pendant amine group. In one such embodiment the filtration media includes a pendant organic receptor group. In another embodiment the filtration media includes a combination of an amine and an organic receptor group that is pendant to one or more surfaces of the filter media.

In embodiments, the filter media of the invention are nonwoven media formed from filter media constituents. The filter media constituents employed to form nonwoven filter media are, for example, thermoplastic fibers, inorganic fibers, thermoplastic or inorganic microfibers or nanofibers, and fiber blends; particulate materials, scrims, or supports; and combinations of these components. In other embodiments the filter media of the invention are membranes having a plurality of pores therethrough. In other embodiments the filter media are particles, porous beads, or nonporous beads. In still other embodiments, the filter media of the invention are structured stacked filtration arrays having a series of flow channels. In some embodiments, one or more such filter media or filter media constituents are combined in a filter construction. Filter constructions include one or more filter media of the invention and one or more supports, wherein the support is e.g. a cartridge, frame, column, scrim, screen, perforated metal plate or cylinder, and the like, wherein the filter constructions are configured to allow a mobile fluid to pass therethrough and further cause the fluid to contact the filter media of the invention. The filter constructions of the invention are useful for the active or passive filtration of fluids containing one or more infectious agents, in which a filtration process causes at least some of the infectious agents to be removed from the fluid.

The filter media of the invention have microbial removal, micro-biocidal or static growth capabilities. In embodiments the filter media include a microbial capture mechanism on a fiber, membrane, particle, bead, or structured stacked array. The capture mechanism can be loaded by weight (e.g. mg-gm⁻¹) or area (mg-cm⁻²) of the filtration media or of the fibers, particles, etc. that are constituents of the filter media. The capture mechanism includes at least a microbial capture agent or capture chemistry or binding composition cooperating with the filter media to capture organisms from a mobile fluid. In use the filter media, in its varying embodiments, is contacted with a mobile fluid including one or more organisms. The capture mechanism interacts with the mobile fluid, wherein the capture chemistry combined with other filter media characteristics causes bonding to the organism surface, thereby capturing a substantial portion of the organisms contacting the filter medium.

In conjunction with the capture chemistry, the filter media of the invention include, in some embodiments, a micro-biocidal or static growth characteristic. In embodiments, the captured organisms are rendered essentially non-active or “killed”; in other embodiments the captured organisms retain at least some minimum metabolic functionality. In both such embodiments, cooperation between the capture mechanism and the physical properties of the filter media prevent microbes from being infective agents upon capture.

### DETAILED DESCRIPTION

### Definitions

For the purpose of this disclosure, the term “fluid” means a chemical or mixture of chemicals that is in a gas or liquid state at the temperature wherein a filtration operation is carried out. The fluid types are not particularly limited, but often are gases and liquids found in household, medical or hospital, food service, or industrial production facilities settings. Common fluids include, for example, air and water.

For the purpose of this disclosure, the term “capable of removing a challenge population of target organisms to a degree that a fluid is substantially non-infective” indicates that a gas or liquid, when contacted with the filter media of the invention, is rendered substantially harmless due to a reduction in the microbial population measured in colony forming units (CFU) using an industry standard Total Viable Count Technique (VCT). The VCT technique is typically reported in CFU-cm⁻³ for fluids. For example, a bacteria-bearing fluid is passed through a filter media of the invention, wherein the filter media collects a representative number of microorganisms from a predetermined volume of the fluid. Depending on the degree of contamination, the fluid that has passed through the filter media is plated out using serial decimal dilutions, using (e.g.) the Miles and Misra Total Viable Count technique, and incubated at 37° C. overnight (inverted). The number of colony forming units (CFU), each typically representing a viable bacterial individual, can then be counted and used to determine the degree of bacterial removal from the fluid attained by the filter media of the invention. In some embodiments, a fluid considered to be fully sanitized (rendered non-infective) when the microbial populations are reduced by at 99.999% (i.e) at least five orders of magnitude 5 log₁₀. In other words, with an initial population of approximately 10⁵ CFU, less than one CFU remains after the filtration. The filter media of the invention, and the filter apparatuses made using these filter media, reduce microbial surface populations by 90%, for example at least 99%, (i.e.) a 2 log₁₀, 99.9% (i.e.) a 3 log₁₀, or 99.99%, (i.e.) a 4 log₁₀ reduction and achieve at least some degree of microbial prophylaxis. The filter media of the invention are capable of a full sanitizing regimen with a 5 log₁₀ (“5 log”) reduction.

In another measure of target organism removal, the filter media of the invention can remove a microbial population from a fluid until the fluid contains less than a minimum infective dose (MID) of an organism, wherein the removal is sufficient to prevent an individual from acquiring a MID of an organism from the fluid. Table 1 shows MID for a series of representative organisms.

TABLE 1
Minimum Effective Doses (MID) for a Range of Organisms

| Organism | MID |
|---|---|
| Salmonella spp. | 11⁴-10⁷ |
| Salmonella Typhi | 10 |
| E. Coli 0157:H7 | 10-10² |
| Vibrio Cholerae | 10³ |
| Gardia Intestinalis | 10-10² |
| Cryptosporidium parvius | 10-10² |
| Ent amoeba histolytica | 10-10² |
| Hepatitis A virus | 1-10 Pfu |

For the purpose of this disclosure, the term “organism”, “microbe” or “microorganism” refers to any bacteria, fungus, virus, or other infective structure including prions, etc. or toxins thereof having a surface chemistry capable of binding with a removal unit present on the filter media or filter media constituent of the invention.

For the purpose of this disclosure, the term “ligand” refers to a binding site on a microbial surface such as a polysaccharide, protein, peptide or polypeptide.

For the purpose of this disclosure, the term “peptide” or “polypeptide” refers to a compound including two or more amino acid residues joined by amide bond(s).

For the purpose of this patent disclosure the term “capture/removal chemistry” indicates a polyamine compound as defined below or a building block structure or both in a capture unit as defined below.

As used herein “capture unit” can comprise removal unit and other chemistry such a a tether or linker, and a “removal unit” can comprise the capture/removal chemistry or a portion of the capture/removal chemistry within a building block or tether (see table 2 and related text for details of the removal agent).

For the purpose of this disclosure, the term “removal unit” refers to the capture chemistry or a portion thereof, optionally with a building block or tether.

“Building block” can be visualized as including several components, such as one or more linkers, one or more removal units, and/or one or more tethers. The linker can be covalently coupled to the support. The linker can be coupled to a support through one or more of covalent, electrostatic, hydrogen bonding, van der Waals, or like interactions. The removal unit can be covalently coupled to the support. The tether can be covalently coupled to the linker and to the support. In an embodiment, a building block includes a support, a linker, a removal unit, and a tether. In an embodiment, a building block includes a linker, a tether, and two removal units.

For the purpose of this disclosure, the term “capture agent” refers to an immobilized removal unit that binds a ligand at a predetermined loading of removal unit.

“Tether” is a group or moiety that can provide spacing or distance between any component and any other component or distance between any component (e.g., the removal unit) and the support or scaffold to which the building block is immobilized. A tether moiety can have any of a variety of characteristics or properties including flexibility, rigidity or stiffness, ability to bond to another tether moiety, and the like. The tether moiety can include the linker group. The support moiety can be envisioned as forming all or part of the tether moiety.

For the purposes of this disclosure, the term “linker” means a portion of or a functional group on a building block that can be employed to or that does (e.g., reversibly) couple the building block to a support, for example, through covalent link, ionic interaction, electrostatic interaction, or hydrophobic interaction.

For the purpose of this disclosure, the term “amine” means a compound with a primary amine (—NH₂) or a secondary amine (—NH—) group.

For the purpose of this disclosure, the term “polyamine” means a compound having more than one primary and/or secondary amine group, including polymers containing repeating units of a secondary amine (—NH) with alternating units of a C₂₋₁₀ alkylene group and, in some embodiments, terminal primary amine groups.

For the purpose of this disclosure, the term “filter media constituent” means a fiber, particle, or other article that is functionalized with one or more building blocks and is useful to form a filter media.

For the purposes of this disclosure, the term “filter media” means a stationary phase media that allows one or more mobile fluids to pass there through and that is functionalized with one or more building blocks.

For the purposes of this disclosure, the term “filter construction” means a filter media disposed within or including one or more supports (support articles). The support surrounds, houses, or supports the filter media of the invention in a manner that allows the filter media to function under the intended conditions while in use.

For the purposes of this disclosure, the term “filter” means an article that employs either the filter media itself or a filter construction as part of an overall filter apparatus. A filter is characterized in that it includes all of the basic infrastructure necessary to carry out a filtration process.

For the purposes of this disclosure, the term “filtration” means the process by which undesirable organisms are removed from a mobile fluid by adsorption or absorption of the organisms into or onto the filter media of the invention via the interaction of capture agents with organisms. For the purposes of this disclosure, the term “physical filtration” or “mechanical filtration” means the sieve-type separation of solids (that in some embodiments include one or more organisms) from one or more fluids by a filter media.

The term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

“Optional” or “optionally” means that the subsequently described event or circumstance may but need not occur, and that the description includes instances where the event or circumstance occurs and instances in which it does not. For example, “A optionally B” means that B may but need not be present, and the description includes situations where A includes B and situations where A does not include B.

“Includes” or “including” or like terms means “includes, but not limited to.”

The present invention may suitably comprise, consist of, or consist essentially of, any of the disclosed or recited elements. Thus, the invention illustratively disclosed herein can be suitably practiced in the absence of any element which is not specifically disclosed herein.

### Capture Agents and Methods

The filter media or filter media constituents of the invention include one or more capture agents bound thereto, in one or more of a number of chemical configurations. The chemical configurations of the capture agents and associated chemical structures are described in this section. Methods of making these chemical structures and employing them on a surface of a filter media or filter media constituent are also described.

The capture agent is part of a building block. The building block is a chemical moiety or group of moieties that are bound to one or more surfaces of a filter constituent or filter media. The filter constituent or filter media is thus a substrate, and the building blocks containing the capture agent is bound to the substrate. The building block includes, in some embodiments, one or more elements in addition to the capture agent. For example the building block includes, in some embodiments, a tether or a linker. The capture agent includes at least one removal unit, that is, a chemical moiety that is the chemical means for interaction with an organism that results in removal, or capture, of the organism from the mobile fluid. In some embodiments, the substrate is functionalized directly with the removal unit, such that the removal unit represents the entirety of the building block. Thus, in some non-limiting examples, building blocks bound to the surface of a substrate are schematically represented in the following manner:
SUBSTRATE—BUILDING BLOCK
SUBSTRATE—TETHER—LINKER—CAPTURE AGENT
SUBSTRATE—LINKER—TETHER—CAPTURE AGENT
SUBSTRATE—LINKER—CAPTURE AGENT
SUBSTRATE—TETHER—CAPTURE AGENT
SUBSTRATE—TETHER—LINKER—REMOVAL UNIT
SUBSTRATE—LINKER—TETHER—REMOVAL UNIT
SUBSTRATE—LINKER—REMOVAL UNIT
SUBSTRATE—TETHER—REMOVAL UNIT
SUBSTRATE—TETHER—REMOVAL UNITS (more than 1)
SUBSTRATE—LINKER—REMOVAL UNITS
SUBSTRATE—REMOVAL UNITS
SUBSTRATE—BUILDING BLOCK [REMOVAL UNITS]
SUBSTRATE—BUILDING BLOCK—TETHER—BUILDING BLOCK
SUBSTRATE—BUILDING BLOCK—LINKER—BUILDING BLOCK
SUBSTRATE—LINKER—BUILDING BLOCK
SUBSTRATE—TETHER—BUILDING BLOCK

In embodiments, the capture agent is in the form of an amine or a capture agent similar to the units described in U.S. Pat. No. 7,469,076 or 7,504,364, which are expressly incorporated by reference herein for the teaching of binding units on a surface. In various embodiments, any one or more of the filter media or filter media constituents described above contain one or more removal units. In some such embodiments, the removal unit is situated at an end of a building block, tether, link or other organic structure(s). In some embodiments, the building block, tether, link or other organic structure(s) include a support moiety located at or forming that end of the building block. In some such embodiments, the removal units are coupled to the support moiety. In some embodiments, a building block further includes a tether moiety.

In embodiments, the tether moiety provides spacing or distance between the removal unit and the filter media or filter media constituent. The tether moiety has any of a variety of characteristics or properties including flexibility, rigidity or stiffness, ability to bond to another tether moiety, and the like. In some embodiments, the tether moiety includes the linker. In embodiments, the support moiety includes all or part of the tether moiety.

In embodiments, the tether includes groups suitable for coupling one tether building block to another, or one tether to another. Such coupling can provide, for example, rigidity or positioning to a building block with a flexible tether. Such coupling can maintain, for example, two building blocks in proximity to one another. The coupling can be reversible, which can allow the coupled building blocks to “change partners” and couple to no or a different building block.

In some such embodiments, the capture agent further includes one of or a plurality of building blocks, wherein one or more of the building blocks has a tether moiety. For example, a capture agent can include at least one building block without a tether moiety, at least one building block with a linker suitable for reversible immobilization on a support moiety, or at least one tether building block. For example, a capture agent can include a plurality of tether building blocks, which can include at least one building block including a rigid tether or at least one building block including a flexible tether.

The present invention relates to a method of making a capture agent or a candidate capture agent. In an embodiment, this method includes preparing a region on a filter media or a filter media constituent, the region including one of, or a plurality of, building blocks immobilized on the filter media or filter media constituent. In some such embodiments, one or more of the building blocks includes a tether moiety. In embodiments, the method includes forming a building block on any of the filter media or filter media constituents described above. In an embodiment, at least one of the building blocks in the fiber includes a tether. In an embodiment, an array of such spots is referred to as a heterogeneous building block array.

In various embodiments, the method includes mixing chemical moieties that include one or more building blocks, and employing the mixture in or on the filter media or filter media constituent. Coupling a building block to the support moiety employs, in various embodiments, covalent bonding or noncovalent interactions. Suitable noncovalent interactions include interactions between ions, hydrogen bonding, van der Waals interactions, and the like. In an embodiment, the filter media or filter media constituent is functionalized with a removal unit that is capable of engaging in a binding association with a microbial surface or covalent bonding or noncovalent bonding interactions.

In embodiments, the method includes immobilizing building blocks on a filter media or filter media constituent using known methods for coupling (immobilizing) compounds of the types employed as described herein. Coupling to the filter media or filter media constituent employs covalent bonding or noncovalent interactions. Suitable noncovalent interactions include interactions between ions, hydrogen bonding, van der Waals interactions, and the like. In an embodiment, the filter media or filter media constituent is functionalized with moieties that are capable of reversible covalent bonding, moieties that are capable of noncovalent interactions, a mixture of these moieties, and the like.

In some embodiments, the filter media or filter media constituents of the invention are functionalized with moieties capable of engaging in covalent bonding. In some such embodiments, the covalent bonding is reversible covalent bonding. In various embodiments, the present invention employs any one or more of a variety of the numerous known functional groups, reagents, and reactions for forming reversible covalent bonds. Suitable reagents for forming reversible covalent bonds include those described in Green, T. W. and Wuts, P. G. M. (1999), Protective Groups in Organic Synthesis, 3^{rd} Ed., Wiley-Interscience, New York (779 pp.). The filter media or filter media constituent includes, in various embodiments, one or more functional groups including a carbonyl group, a carboxyl group, a silane group, a boric acid or ester group, an amine group (e.g., a primary, secondary, or tertiary amine, a hydroxylamine, a hydrazine, or the like), a thiol group, an alcohol group (e.g., primary, secondary, or tertiary alcohol), a diol group (e.g., a 1,2 diol or a 1,3 diol), a phenol group, a catechol group, or the like. In embodiments, these functional groups form reversible covalent bonds. Representative reversible covalent bonds include ether (e.g., alkyl ether, silyl ether, thioether, or the like), ester (e.g., alkyl ester, phenol ester, cyclic ester, thioester, or the like), acetal (e.g., cyclic acetal), ketal (e.g., cyclic ketal), silyl (e.g., silyl ether), boronate (e.g., cyclic boronate), amide, hydrazide, imine, or carbamate bonds. Such functional groups are referred to as a covalent bonding moieties, e.g., a first covalent bonding moiety.

A carbonyl group present on the filter media or filter media constituent, contacted with an amine group on a building block, can form an imine or Schiff base. The same is true of an amine group on the filter media or filter media constituent that is paired with a carbonyl group on a building block. A carbonyl group on the filter media or filter media constituent and an alcohol group on a building block can form an acetal or ketal. The same is true of an alcohol group on the filter media or filter media constituent and a carbonyl group on a building block. A thiol (e.g., a first thiol) on the filter media or filter media constituent and a thiol (e.g., a second thiol) on the building block can form a disulfide.

A carboxyl group on the filter media or filter media constituent and an alcohol group on a building block can form an ester. The same is true of an alcohol group on the filter media or filter media constituent and a carboxyl group on a building block. Any of a variety of alcohols and carboxylic acids can form esters that provide covalent bonding that can be reversed in the context of the present invention. For example, reversible ester linkages are formed from alcohols such as phenols with electron withdrawing groups on the aryl ring, other alcohols with electron withdrawing groups acting on the hydroxyl-bearing carbon, other alcohols, or the like; and/or carboxyl groups such as those with electron withdrawing groups acting on the acyl carbon (e.g., nitrobenzylic acid, R—CF₂—COOH, R—CCl₂—COOH, and the like), other carboxylic acids, or the like.

In some embodiments, the filter media or filter media constituents of the invention are functionalized with moieties that can engage in noncovalent interactions. For example, in embodiments the filter media or filter media constituent includes a functional group such as a charged moiety, an ionic group, a group that can hydrogen bond, or a group that is capable of van der Waals type or other hydrophobic interactions. Such functional groups include cationic groups, anionic groups, lipophilic groups, amphiphilic groups, and the like.

In an embodiment, the support moiety includes a lipophilic moiety (e.g., a first lipophilic moiety). Suitable lipophilic moieties include branched or straight chain C₆₋₃₆ alkyl, C₈₋₂₄ alkyl, C₁₂₋₂₄alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double (alkenyl) bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple (alkynyl) bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; intrachain functionality such as ether groups; or terminal functionality such as alcohol, amide, carboxylate or the like. In some embodiments, the lipophilic moiety includes a quaternary ammonium group bearing the lipophilic moiety; in such embodiments, the lipophilic moiety includes a positive charge (cation).

The present invention relates to building blocks for making or forming candidate capture agents. Building blocks are designed, made, and selected to provide a variety of structural characteristics such as positive charge, negative charge, acid functionality, base functionality, electron acceptor functionality, electron donor functionality, hydrogen bond donor functionality, hydrogen bond acceptor functionality, free electron pair functionality, π electron functionality, charge polarization functionality, hydrophilic functionality, hydrophobic functionality, and the like. In some embodiments the building block is sterically bulky.

In various embodiments, the building block includes several components. These components include one or more linkers, one or more removal units, and/or one or more tethers. The filter media or filter media constituent can be covalently coupled to any of the building block components. The linker can be covalently coupled to the filter media or filter media constituent. The linker can be coupled to a filter media or filter media constituent through one or more of covalent, electrostatic, hydrogen bonding, van der Waals, or like interactions. The removal unit can be covalently coupled to the filter media or filter media constituent. The tether can be covalently coupled to the linker and to the filter media or filter media constituent. In an embodiment, a building block includes a support moiety, a linker, a removal unit, and a tether. In an embodiment, a building block includes a filter media or filter media constituent, a linker, a tether, and two removal units.

A description of general and specific features and functions of a variety of building blocks and their synthesis can be found in U.S. patent application Ser. No. 10/244,727, filed Sep. 16, 2002, Ser. No. 10/813,568, filed Mar. 29, 2004, and Application No. PCT/US03/05328, filed Feb. 19, 2003, each entitled “ARTIFICIAL RECEPTORS, BUILDING BLOCKS, AND METHODS”; U.S. patent application Ser. Nos. 10/812,850 and 10/813,612, and application No. PCT/US2004/009649, each filed Mar. 29, 2004 and each entitled “ARTIFICIAL RECEPTORS INCLUDING REVERSIBLY IMMOBILIZED BUILDING BLOCKS, THE BUILDING BLOCKS, AND METHODS”; and U.S. Provisional Patent Application No. 60/499,965, filed Sep. 3, 2003, and 60/526,699, filed Dec. 2, 2003, each entitled BUILDING BLOCKS FOR ARTIFICIAL RECEPTORS; the disclosures of which are incorporated herein by reference in their entirety. These patent documents include, in particular, a detailed written description of: function, structure, and configuration of building blocks, removal units, synthesis of building blocks, specific embodiments of building blocks, specific embodiments of removal units, and sets of building blocks.

This embodiment of a removal unit can be selected for functional groups that provide for coupling to the removal unit and for coupling to or being the tether and/or linking moieties. The removal unit can interact with the ligand as part of the capture agent including multiple reaction sites with orthogonal and reliable functional groups and with controlled stereochemistry. Suitable functional groups with orthogonal and reliable chemistries include, for example, carboxyl, amine, hydroxyl, phenol, carbonyl, and thiol groups, which can be individually protected, deprotected, and derivatized. In an embodiment, two, three, or four functional groups with orthogonal and reliable chemistries are used. In some embodiments, the removal unit has three functional groups. In such embodiments, the three functional groups can be independently selected, for example, from carboxyl, amine, hydroxyl, phenol, carbonyl, or thiol group and can include alkyl, substituted alkyl, cycloalkyl, heterocyclic, substituted heterocyclic, aryl alkyl, aryl, heteroaryl, heteroaryl alkyl, and like moieties.

A general structure with three functional groups can be represented by Formula 1ₐ.

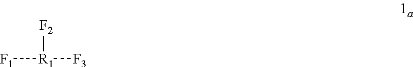

A general structure with four functional groups can be represented by Formula 1_{b}.

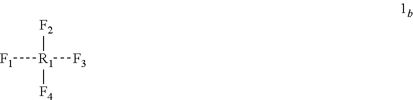

In some embodiments, R₁ is a 1-12, a 1-6, or a 1-4 carbon linear, branched, or cyclic alkyl or substituted alkyl, or a heterocyclic, substituted heterocyclic, aryl alkyl, aryl, heteroaryl, heteroaryl alkyl, or like group. In embodiments, F₁, F₂, F₃, and F₄ are independently carboxyl, amine, hydroxyl, phenol, carbonyl, or thiol groups, or a 1-12, a 1-6, a 1-4 carbon linear, branched, or cyclic alkyl or substituted alkyl, or a heterocyclic, substituted heterocyclic, aryl alkyl, aryl, heteroaryl, heteroaryl alkyl, or like group, or an inorganic group substituted with carboxyl, amine, hydroxyl, phenol, carbonyl, or thiol group. In some embodiments, F₃ and/or F₄ are absent or are groups that are not functional groups.

A variety of compounds fit the formulas and text describing the support group including amino acids and naturally occurring or synthetic compounds including, for example, oxygen and sulfur functional groups. The compounds can be racemic, optically active, or achiral. For example, the compounds can be natural or synthetic amino acids, α-hydroxy acids, thioic acids, and the like.

All of the naturally occurring and many synthetic amino acids are commercially available. Further, forms of these amino acids derivatized or protected to be suitable for reactions for coupling to removal unit(s) and/or linkers can be purchased or made by known methods (see, e.g., Green, T. W. and Wuts, P. G. M. (1999), Protective Groups in Organic Synthesis, 3^{rd} Ed., Wiley-Interscience, New York (779 pp.); or Bodanszky, M. and Bodanszky, A. (1994), The Practice of Peptide Synthesis, 2^{nd} Ed., Springer-Verlag, New York, (217 pp.)).

In an embodiment, the filter media and filter media constituents of the present invention employ a building block that includes a tether moiety. The tether moiety can provide spacing or distance between the removal unit and the support group to which the building block is immobilized. In various embodiments the tether moiety has one or more of a variety of characteristics or properties including, for example, flexibility, rigidity or stiffness, ability to bond to another tether moiety, and the like. In some embodiments, the tether moiety includes a linker.

Suitable tether moieties include, for example, a polyethylene glycol, a polyamide, a linear polymer, a peptide, a polypeptide, an oligosaccharide, a polysaccharide, and a semifunctionalized oligo- or polyglycine. In some embodiments, the tether is or includes a polymer of up to 2000 carbon atoms (e.g., up to 48 carbon atoms). Such a polymer can be naturally occurring or synthetic. Suitable polymers include a polyether or like polymer, such as a polyethylene glycol (PEG), a polyethyleneimine, polyacrylate (e.g., substituted polyacrylates), salt thereof, a mixture or combination thereof, or the like. Suitable PEGs include, where a number designation indicates an average molecular weight, PEG 1500 up to PEG 20,000, for example, PEG 1450, PEG 3350, PEG 4500, PEG 8000, PEG 20,000, and the like, or any molecular weight value in between such molecular weight values.

Additional examples of suitable tether moieties include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄, alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; intrachain functionality such as an ether group; or terminal functionality like alcohol, amide, carboxylate or the like. In some embodiments, the lipophilic moiety includes or is a 12-carbon aliphatic moiety.

Rigid tether moieties include one or more conformationally restricted groups. Examples of conformationally restricted groups include, for example, imines, aromatics, fused bicyclic or polycyclic hydrocarbons, and polyaromatics. Rigid tether moieties can include one or more branched or straight chain C₆₋₃₆ alkenyl, C₈₋₂₄ alkenyl, C₁₂₋₂₄ alkenyl, C₁₂₋₁₈ alkenyl, or the like, with, for example, 2 to 8 double bonds; C₆₋₃₆ alkynyl, C₈₋₂₄ alkynyl, C₁₂₋₂₄ alkynyl, C₁₂₋₁₈ alkynyl, or the like, with, for example, 1 to 8 triple bonds; chains with 3-8 double or triple bonds; chains including aryl or substituted aryl moieties (e.g., phenyl or naphthyl moieties at the end or middle of a chain); polyaromatic hydrocarbon moieties; and the like. The alkenyl or alkynyl group can include branching; intrachain functionality such as an ether group; or terminal functionality like alcohol, amide, carboxylate or the like. Rigid tether moieties can include a steroid moiety, such as cholesterol, a corrin or another porphyrin, a polynuclear aromatic moiety, a polar polymer fixed with metal ions, or the like.

In an embodiment, a rigid tether moiety includes more than one tether moiety. For example, a rigid tether moiety can include a plurality of hydrophobic chains, such as those described in the paragraph above and in the paragraph below. The hydrophobic chains if held in sufficient proximity on the surface of a filter media or filter media constituent will, in the presence of a hydrophilic fluid, form a grouping sufficiently rigid to hold one or more sets of removal units in place. In another embodiment, a rigid tether moiety includes a plurality of otherwise flexible tether moieties crosslinked to one another. The crosslinking can include, for example, covalent bonding, electrostatic interactions, hydrogen bonding, or hydrophobic interactions. Groups for forming such interactions are disclosed herein.

Flexible tether moieties can include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C.sub.12-24 alkenyl, C₁₂₋₁₈ alkenyl, or the like, with, for example, 1 to 2 double bonds; C₆₋₃₆ alkynyl, C₈₋₂₄ alkynyl, C₁₂₋₂₄ alkynyl, C₁₂₋₁₈ alkynyl, or the like, with, for example, to 2 triple bonds; chains with 1-2 double or triple bonds; chains including 1 to 2 aryl or substituted aryl moieties (e.g., phenyl or naphthyl moieties at the end or middle of a chain); cycloalkane or substituted alkane moieties with numbers of carbons as described for chains; combinations or mixtures thereof; or the like. The alkyl, alkenyl, or alkynyl group can include branching; intrachain functionality like an ether group; or terminal functionality like alcohol, amide, carboxylate or the like. In some such embodiments, the lipophilic moiety includes or is a 12-carbonaliphatic moiety.

In some embodiments, the tether forms or is capable of forming a covalent bond with a support group present on the filter media or filter media constituent where, for example, the support group includes an alcohol, phenol, thiol, amine, carbonyl, or like group. Optionally situated between the bond to the support group and the group participating in or formed by the interaction with the support group, is a linker. In some embodiments the linker includes an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

Suitable tethers include, for example: the functional group participating in or formed by the bond to the support group, the functional group or groups participating in or formed by the interaction with the support group, and a tether backbone moiety. The tether backbone moiety can include about 8 to about 200 carbon atoms or heteroatoms, about 12 to about 150 carbon atoms or heteroatoms, about 16 to about 100 carbon atoms or heteroatoms, about 16 to about 50 carbon atoms or heteroatoms, or the like. The tether backbone can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, mixtures thereof, or like moiety. Suitable tethers have structures such as (CH₂)ₙCOOH, with n=12-24, n=17-24, or n=16-18.

The tether can interact with the ligand as part of the capture agent. The tether can also impart bulk, distance from the surface of the filter media or filter media constituent, hydrophobicity, hydrophilicity, and/or other physical or structural characteristics to the building block. In an embodiment, the tether forms a covalent bond with a functional group on the support group. In an embodiment, the tether further includes a functional group that can couple to the tether or to the support group, for example via covalent bonding or noncovalent interactions.

In some embodiments, a first tether moiety includes one or more moieties for forming a reversible covalent bond, a hydrogen bond, or an ionic interaction, e.g., with a second tether moiety. In some such embodiments the linker includes about 1 to about 20 reversible bond/interaction moieties or about 2 to about 10 reversible bond/interaction moieties.

In some embodiments, the tether includes one or more moieties that can engage in reversible covalent bonding. Suitable groups for such reversible covalent bonding include those reversible covalent bonding moieties described hereinabove. In some such embodiments, the groups for reversible covalent bonding are part of links between tether moieties (tether-tether links). Examples of tether-tether links include imine, acetal, ketal, disulfide, ester, or like linkages. Such functional groups can engage in reversible covalent bonding. A building block (whether including a tether group or not) reversibly immobilized by an imine, acetal, or ketal bond can be mobilized by decreasing the pH or increasing concentration of a nucleophilic catalyst in the environs of the building block. In an embodiment, the pH of the fluid contacted with the filter media of the invention is between about 1 to 4. Imines, acetals, and ketals undergo acid catalyzed hydrolysis. A building block that is mobile on a support moiety can be reversibly immobilized by a reversible covalent interaction, such as by forming an imine, acetal, or ketal bond, by increasing the pH.

In some embodiments, the tether is functionalized with one or more moieties that can engage in noncovalent interactions. For example, the tether can include functional groups such as a group that can engage in ionic bonding, a group that can engage in hydrogen bonding, or a group that can engage in van der Waals or other hydrophobic interactions/bonding. Such functional groups can include cationic groups, anionic groups, lipophilic groups, amphiphilic groups, and the like.

In an embodiment, the present methods and compositions can employ a tether including a charged moiety. Suitable charged moieties include positively charged moieties and negatively charged moieties. Examples of suitable positively charged moieties include protonated amines, quaternary ammonium, sulfonium, sulfoxonium, phosphonium, ferrocene, and the like. Examples of suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In embodiments, the present methods and compositions employ a tether including a group capable of forming a hydrogen bond, either as donor or acceptor (e.g., a second hydrogen bonding group). For example, the tether can include one or more carboxyl groups, amine groups, hydroxyl groups, carbonyl groups, or the like. In some embodiments the tether includes an ionic group capable of participating in hydrogen bonding.

In some embodiments the removal unit is a polyamine or a 1-12, a 1-6, or a 1-4 carbon alkyl, substituted alkyl, cycloalkyl, heterocyclic, substituted heterocyclic, aryl alkyl, aryl, heteroaryl, heteroaryl alkyl, or like group optionally including one or more amine moieties. The removal unit can be substituted with a group that includes or imparts positive charge, negative charge, acid, base, electron acceptor, electron donor, hydrogen bond donor, hydrogen bond acceptor, free electron pair, π electrons, charge polarization, hydrophilicity, hydrophobicity, and the like.

Formulas A1-A9 and B1-B9 are shown in Table 2 and are referred to below.

TABLE 2

| | |
|---|---|
| A1 | CH₃—CH₂— |
| A2 | (CH₃)₂—CH—CH₂— |
| A3 | 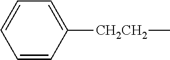 |
| A3a | 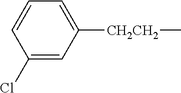 |
| A4 | 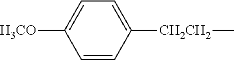 |
| A5 | 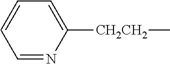 |
| A6 | —CH₂—CH₂—OCH₃ |
| A7 | —CH₂—CH₂—OH |
| A8 | —CH₂—CH₂—NH—C(O)—CH₃ |
| A9 | 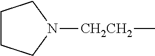 |
| B1 | CH₃— |
| B2 | 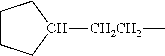 |
| B3 | 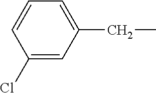 |
| B3a | 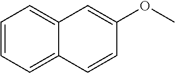 |
| B4 | 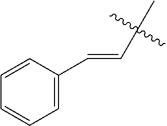 |
| B5 | 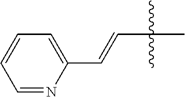 |
| B6 | CH₃—S—CH₂— |
| B7 | CH₃CH(OH)CH₂— |
| B8 | —CH₂CH₂C(O)—NH₂ |
| B9 | (CH₃)₂—N—CH₂CH₂CH₂— |

Representative examples of suitable removal units with a positive charge (e.g., at neutral pH in aqueous compositions) include protonated amines, quaternary ammonium moieties, sulfonium, sulfoxonium, phosphonium, ferrocene, and the like. Suitable amines include alkyl amines, alkyl diamines, heteroalkyl amines, aryl amines, heteroaryl amines, aryl alkyl amines, pyridines, heterocyclic amines (saturated or unsaturated, the nitrogen in the ring or not), amidines, hydrazines, and the like. Alkyl amines generally have 1 to 12 carbon atoms, for example 1-8 carbon atoms, and rings can have 3-12 carbon atoms, for example 3-8 carbon atoms. Suitable alkyl amines include that of formula B9. Suitable heterocyclic or alkyl heterocyclic amines include that of formula A9. Suitable pyridines include those of formulas A5 and B5. Any of these or other examples of suitable amines can be employed as a corresponding quaternary ammonium compound. Examples of suitable quaternary ammonium moieties include trimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

Removal units with a negative charge (e.g., at neutral pH in aqueous compositions) include carboxylates, phenols substituted with strongly electron withdrawing groups (e.g., substituted tetrachlorophenols), phosphates, phosphonates, phosphinates, sulphates, sulphonates, thiocarboxylates, and hydroxamic acids. Suitable carboxylates include alkyl carboxylates, aryl carboxylates, and aryl alkyl carboxylates. Suitable phosphates include phosphate mono-, di-, and tri-esters, and phosphate mono-, di-, and tri-amides. Suitable phosphonates include phosphonate mono- and di-esters, and phosphonate mono- and di-amides (e.g., phosphonamides). Suitable phosphinates include phosphinate esters and amides.

Removal units with both a negative charge and a positive charge (at neutral pH in aqueous compositions) include sulfoxides, betaines, and amine oxides.

Acidic removal units can include carboxylates, phosphates, sulphates, and phenols. Suitable acidic carboxylates include thiocarboxylates. Suitable acidic phosphates include the phosphates listed hereinabove.

Basic reacting removal units include-amines. Suitable basic amines include alkyl amines, aryl amines, aryl alkyl amines, pyridines, heterocyclic amines (saturated or unsaturated, the nitrogen in the ring or not), amidines, and any additional amines listed hereinabove. Suitable alkyl amines include that of formula B9. Suitable heterocyclic or alkyl heterocyclic amines include that of formula A9. Suitable pyridines include those of formulas A5 and B5.

Removal units including a hydrogen bond donor include amines, amides, carboxyls, protonated phosphates, protonated phosphonates, protonated phosphinates, protonated sulphates, protonated sulphinates, alcohols, and thiols. Suitable amines include alkyl amines, aryl amines, aryl alkyl amines, pyridines, heterocyclic amines (saturated or unsaturated, the nitrogen in the ring or not), amidines, ureas, and any other amines listed hereinabove. Suitable alkyl amines include that of formula B9. Suitable heterocyclic or alkyl heterocyclic amines include that of formula A9. Suitable pyridines include those of formulas A5 and B5. Suitable protonated carboxylates and protonated phosphates include those listed hereinabove. Suitable amides include those of formulas A8 and B8. Suitable alcohols include primary alcohols, secondary alcohols, tertiary alcohols, and aromatic alcohols (e.g., phenols). Suitable alcohols include those of formulas A7 (a primary alcohol) and B7 (a secondary alcohol).

Removal units including a hydrogen bond acceptor or one or more free electron pairs include amines, amides, carboxylates, carboxyl groups, phosphates, phosphonates, phosphinates, sulphates, sulphonates, alcohols, ethers, thiols, and thioethers. Suitable amines include alkyl amines, aryl amines, aryl alkyl amines, pyridines, heterocyclic amines (saturated or unsaturated, the nitrogen in the ring or not), amidines, ureas, and amines as listed hereinabove. Suitable alkyl amines include that of formula B9. Suitable heterocyclic or alkyl heterocyclic amines include that of formula A9. Suitable pyridines include those of formulas A5 and B5. Suitable carboxylates include those listed hereinabove. Suitable amides include those of formulas A8 and B8. Suitable phosphates, phosphonates and phosphinates include those listed hereinabove. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include alkyl ethers, aryl alkyl ethers. Suitable alkyl ethers include that of formula A6. Suitable aryl alkyl ethers include that of formula A4. Suitable thioethers include that of formula B6.

Removal units including uncharged polar or hydrophilic groups include amides, alcohols, ethers, thiols, thioethers, esters, thio esters, boranes, borates, and metal complexes. Suitable amides include those of formulas A8 and B8. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include those listed hereinabove. Suitable ethers include that of formula A6. Suitable aryl alkyl ethers include that of formula A4.

Removal units having uncharged hydrophobic groups include those having alkyl (branched, linear, cyclic; substituted and unsubstituted), alkene (conjugated and unconjugated), alkyne (conjugated and unconjugated), and aromatic groups. Suitable alkyl groups include alkyl groups having between 1 and 6 carbon atoms, substituted alkyl, cycloalkyl, aryl alkyl, and heteroaryl alkyl. Suitable lower alkyl groups include those of formulas A1, A2, A3, and B1. Suitable aryl alkyl groups include those of formulas A3, A3a, A4, B3, B3a, and B4. Suitable alkyl cycloalkyl groups include that of formula B2.

Suitable alkene groups include lower alkene and aryl alkene. Suitable aryl alkene groups include that of formula B4. Suitable aromatic groups include unsubstituted aryl, heteroaryl, substituted aryl, aryl alkyl, heteroaryl alkyl, alkyl substituted aryl, and polyaromatic hydrocarbons. Suitable alkyl heteroaryl groups include those of formulas A5 and B5.

Spacer (e.g., small) removal units include hydrogen, methyl, ethyl, and the like, that is, moieties having 6 or less carbon atoms, heteroatoms, or combination thereof. Higher, and in some embodiments sterically bulky, removal units include 7 or more carbon atoms, heteroatoms, or combination thereof.

These A and B group formulas of Table 2 are substituents of, according to a standard reference: A1, ethylamine; A2, isobutylamine; A3, phenethylamine; A4, 4-methoxyphenethylamine; A5,2-(2-aminoethyl)pyridine; A6,2-methoxyethylamine; A7, ethanolamine; A8, N-acetylethylenediamine; A9,1-(2-aminoethyl)pyrrolidine; B1, acetic acid, B2, cyclopentylpropionic acid; B3,3-chlorophenylacetic acid; B4, cinnamic acid; B5,3-pyridinepropionic acid; B6, (methylthio)acetic acid; B7,3-hydroxybutyric acid; B8, succinamic acid; and B9,4-(dimethylamino)butyric acid.

In an embodiment, the removal units include one or more of the structures represented by formulas A1, A2, A3, A3a, A4, A5, A6, A7, A8, and/or A9 (the A removal units) and/or B1, B2, B3, B3a, B4, B5, B6, B7, B8, and/or B9 (the B removal units). In an embodiment, each building block includes an A removal unit and a B removal unit. In an embodiment, a group of 81 such building blocks includes each of the 81 unique combinations of an A removal unit and a B removal unit. In some embodiments, the A removal units are linked to a support group in a pendant position relative to the filter media constituent surface; that is, the A removal unit projects substantially away from the overall filter media constituent surface. In some embodiments, the B removal units are linked to a support group in an equatorial position, that is, the B removal unit projects in a direction that is substantially parallel to the overall filter media constituent surface. In an embodiment, the A removal units are linked to a support group at a pendant position and the B removal units are linked to the support group at an equatorial position.

Although not limiting to the present invention, it is believed that in some such embodiments the A and B removal units represent the assortment of functional groups and geometric configurations employed by polypeptide receptors. Although not limiting to the present invention, it is believed that the A removal units represent six advantageous functional groups or configurations and that the addition of functional groups to several of the aryl groups increases the range of possible binding interactions. Although not limiting to the present invention, it is believed that the B removal units represent six advantageous functional groups, but in different configurations than employed for the A removal units. Although not limiting to the present invention, it is further believed that this increases the range of binding interactions and further extends the range of functional groups and configurations that is explored by molecular configurations of the building blocks.

In an embodiment, the building blocks including the A and B removal units can be visualized as occupying a binding space defined by lipophilicity/hydrophilicity and volume. A volume can be calculated (using known methods) for each building block including the various A and B removal units. A measure of lipophilicity/hydrophilicity (logP) can be calculated (using known methods) for each building block including the various A and B removal units. Negative values of logP show affinity for water over nonpolar organic solvent and indicate a hydrophilic nature. A plot of volume versus logP can then show the distribution of the building blocks through a binding space defined by size and lipophilicity/hydrophilicity.

Reagents that form many of the removal units are commercially available. For example, reagents for forming removal units A1, A2, A3, A3a, A4, A5, A6, A7, A8, A9 B1, B2, B3, B3a, B4, B5, B6, B7, B8, and B9 are commercially available.

The linker is selected to provide a suitable coupling of the building block to a support group. In some embodiments, the linker interacts with the ligand as part of the capture agent. In some embodiments the linker provides one or more properties such as steric bulk, distance from the support group, hydrophobicity, hydrophilicity, and the like to the building block. Coupling of the building blocks to the support group employs covalent bonding or noncovalent interactions. Suitable noncovalent interactions include ionic bonding or interactions, hydrogen bonding, van der Waals interactions, and the like.

In some embodiments, the linker includes one or more moieties that can engage in either covalent bonding or noncovalent interactions. In some embodiments, the linker includes moieties that can engage in covalent bonding. In some such embodiments, the covalent bonding is reversible covalent bonding. Suitable groups for forming covalent and reversible covalent bonds are described hereinabove.

The linker can be selected to provide suitable reversible immobilization of the building block on the filter media or filter media constituents of the invention. In some embodiments, the linker forms a covalent bond with a support group on the filter media or filter media constituent. In an embodiment, the linker also includes a functional group that can reversibly interact with the support moiety, e.g., through reversible covalent bonding or noncovalent interactions.

In an embodiment, the linker includes one or more moieties that can engage in reversible covalent bonding. Suitable groups for reversible covalent bonding include those described hereinabove. For example, a capture agent can include building blocks reversibly immobilized on the filter media or filter media constituent support groups present on the surface thereof. Support groups having functional groups are shown above as structures 1a and 1b, for example. The functional groups including, for example, imine, acetal, ketal, disulfide, ester, or the like are capable of engaging in reversible covalent bonding. Such functional groups can be referred to as a covalent bonding moiety, e.g., a second covalent bonding moiety.

In some embodiments, the linker is functionalized with moieties that can engage in noncovalent interactions. For example, the linker can include functional groups such as an ionic group, a group that can hydrogen bond, or a group that can engage in van der Waals or other hydrophobic interactions. Such functional groups can include cationic groups, anionic groups, lipophilic groups, amphiphilic groups, and the like.

In some embodiments, the present methods and filter media employ a linker including a charged moiety (e.g., a second charged moiety). Suitable charged moieties include positively charged moieties and negatively charged moieties. Suitable positively charged moieties include protonated amines, quaternary ammonium moieties, sulfonium, sulfoxonium, phosphonium, ferrocene, and the like. Suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In some embodiments, the present methods, filter media, and filter media constituents employ a linker including a functional group that can hydrogen bond, either as donor or acceptor (e.g., a second hydrogen bonding group). For example, the linker can include one or more carboxyl groups, amine groups, hydroxyl groups, carbonyl groups, or the like. Ionic groups can also participate in hydrogen bonding.

In some embodiments, the present methods and filter media employ a linker including a lipophilic moiety (e.g., a second lipophilic moiety). Suitable lipophilic moieties include one or more branched or straight chain C₆₋₃₆ alkyl, C₈₋₁₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; intrachain functionality such as an ether group; or terminal functionality like alcohol, amide, carboxylate or the like. In some embodiments the linker includes or is a lipid, such as a phospholipid. In some embodiments, the lipophilic moiety includes or is a 12-carbon aliphatic moiety.

In some embodiments, the linker includes a lipophilic moiety (e.g., a second lipophilic moiety) and a covalent bonding moiety (e.g., a second covalent bonding moiety). In some embodiments, the linker includes a lipophilic moiety (e.g., a second lipophilic moiety) and a charged moiety (e.g., a second charged moiety).

In some embodiments, the linker forms or is capable of forming a covalent bond with a support group including an alcohol, phenol, thiol, amine, carbonyl, or the like. Between the support group and the group participating in or formed by the reversible interaction with the support group, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

Representative examples of suitable linkers include: the functional group participating in or formed by the support group that is bonded to the filter media or filter media constituent, the functional group or groups participating in or formed by the reversible interaction with the support group, and a linker backbone moiety. The linker backbone moiety can include about 4 to about 48 carbon atoms, heteroatoms, or combination thereof, about 8 to about 14 carbon atoms, heteroatoms, or combination thereof, about 12 to about 24 carbon atoms, heteroatoms, or combination thereof, about 16 to about 18 carbon atoms, heteroatoms, or combination thereof, about 4 to about 12 carbon atoms, heteroatoms, or combination thereof, about 4 to about 8 carbon atoms, heteroatoms, or combination thereof, or the like. The linker backbone can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, mixtures thereof, or like moiety.

In some embodiments, the linker includes a lipophilic moiety, the functional group participating in or formed by the bond to the support group, and, optionally, one or more moieties for forming a reversible covalent bond, a hydrogen bond, or an ionic interaction. In some such embodiments, the lipophilic moiety has about 4 to about 48 carbon atoms, about 8 to about 14 carbon atoms, about 12 to about 24 carbon atoms, about 16 to about 18 carbon atoms, or the like. In such an embodiment, the linker can include about 1 to about 8 reversible bond/interaction moieties or about 2 to about 4 reversible bond/interaction moieties. Suitable linkers have structures such as (CH₂)ₙCOOH, where n=12-24, n=17-24, or n=16-18.

In some embodiments, the linker is selected to provide a suitable covalent coupling of the building block to a support group present on the filter media or filter media constituent. The filter media interacts with the ligand as part of the capture agent. In some such embodiments the linker also provided steric bulk, distance from the media surface, hydrophobicity, hydrophilicity, and like structural characteristics to the building block. In some embodiment, the linker forms a covalent bond with a functional group present on the support group. In an embodiment, before attachment to the filter media or filter media constituent, the linker also includes a functional group that can be activated to react with or that will react with a functional group on the support group, the support group present on the surface of the filter media or filter media constituent. In some such embodiments, once attached to the support group, the linker forms a covalent bond with the support group via the functional group present on the support group, the support group present on the surface of the filter media or filter media constituent of the invention.

In some embodiments, the linker forms or is capable of forming a covalent bond with an alcohol, phenol, thiol, amine, carbonyl, or like functional group present on the support group. In some such embodiments the linker includes a carboxyl, alcohol, phenol, thiol, amine, carbonyl, maleimide, or like group that can react with or be activated to react with the support group present on the surface of the filter media or filter media constituent. In some such embodiments, between the bond to the support group and the group formed by the attachment to the support group, the linker includes an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

The linker can include a suitable leaving group bonded to, for example, an alkyl or aryl group. In embodiments, the leaving group is suitable for displacement by an alcohol, phenol, thiol, amine, carbonyl, or like group that is a functional group on the support group, the support group present on the surface of the filter media or filter media constituent of the invention. Such a linker represented by the formula: R—X, in which X is a leaving group such as halogen (e.g., —Cl, —Br or —I), tosylate, mesylate, triflate, and the like; and R is alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or a like moiety.

Suitable linker groups include those of formula: (CH₁)ₙCOOH, with n=1-16, n=2-8, n=2-6, or n=3. Reagents that form suitable linker groups are commercially available and include any of a variety of reagents with orthogonal functionality.

In an embodiment, removal unit building block(s) can be represented by Formula 2:

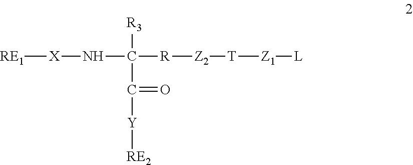

in which: RE₁ is removal unit 1, RE₂ is removal unit 2, and T is a covalent bond or a tether group; L is a linker; X is a covalent bond, C═O, CH₂, NR, NR₂, NH, NHCONH, SCONH, CH═N, or OCH₂NH; Y is a covalent bond, NH, O, CH₂, or NRCO; Z₁ is CH₂, O, NH, S, CO, NR, NR₂, NHCONH, SCONH, CH═N, or OCH₂NH; and Z₂ is a covalent bond, CH₂, O, NH, S, CO, NR, NR₂, NHCONH, SCONH, CH═N, or OCH₂NH. In some embodiments, X is a covalent bond or C=0. In some embodiments, Y is NH or O. In some embodiments, Y is NH. In some embodiments, Z₁ and/or Z₂ are O. In some embodiments, Z₂ is a covalent bond. In some embodiments, R in any of the groups of Formula 2 is H, CH₃, or another group that confers chirality on the building block and has size similar to or smaller than a methyl group. In some embodiments R₃ is CH₂; CH₂-phenyl; CHCH₃; (CH₂)ₙ with n=2-3; or cyclic alkyl with 3-8 carbons, e.g., 5-6 carbons, phenyl, naphthyl. In certain embodiments, R₃ is CH₂ or CH₂-phenyl.

In some embodiments, R₃ represents a group that is bonded to the surface of the filter media constituent. In such embodiments, RE₁ is situated substantially in an equatorial position, whereas RE₂ is situated substantially in a pendant position, as those positions are described herein above.

In some embodiments of Formula 2, RE₁ is B1, B2, B3, B3a, B4, B5, B6, B7, B8, B9, A1, A2, A3, A3a, A4, A5, A6, A7, A8, or A9. In certain embodiments, RE₁ is B1, B2, B3, B3a, B4, B5, B6, B7, B8, or B9. RE₂ is A1, A2, A3, A3a, A4, A5, A6, A7, A8, A9, B1, B2, B3, B3a, B4, B5, B6, B7, B8, or B9. In certain embodiments, RE₂ is A1, A2, A3, A3a, A4, A5, A6, A7, A8, or A9. In certain embodiments, RE₁ can be B2, B3a, B4, B5, B6, B7, or B8. In certain embodiments, RE₂ can be A2, A3a, A4, A5, A6, A7, or A8. In certain embodiments, T is any of the tether moieties described hereinabove.

In some embodiments of Formula 2, L is a linker. In some such embodiments, the linker includes about 4 to about 48 carbon or heteroatom alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or mixtures thereof; or about 8 to about 14 carbon atoms or heteroatoms, about 12 to about 24 carbon atoms or heteroatoms, about 16 to about 18 carbon atoms or heteroatoms, about 4 to about 12 carbon atoms or heteroatoms, about 4 to about 8 carbon atoms or heteroatoms.

In some embodiments of Formula 2, L is a lipophilic moiety of about 4 to about 48 carbons, about 8 to about 14 carbons, or about 12 to about 24 carbons, or about 16 to about 18 carbons. In some such embodiments, L further includes about 1 to about 8 reversible bond/interaction moieties such as any such moieties described above, or about 2 to about 4 reversible bond/interaction moieties. In some such embodiments, L is (CH₂)ₙCOOH, with n=12-24, n=17-24, or n=16-18. In other embodiments, L is (CH₂)ₙCOOH, with n=1-16, n=2-8, n=4-6, or n=3.

In embodiments of the filter media or filter media constituents of the invention, including those having structures corresponding to Formula 2, the removal units (RE₁ and RE₂) are derivatives of compound I, compound II, compound III, compound IV, or compound V as follows.

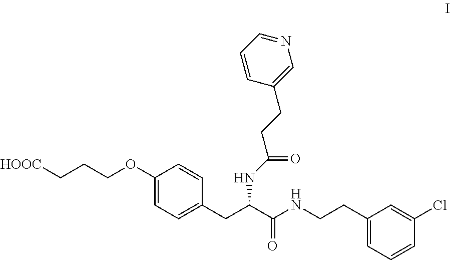

### (S)-4-(4-(3-(3-chlorophenethylamino)-3-oxo-2-(3-(pyridin-3-yl)propanamido)propyl)phenoxy)butanoic acid

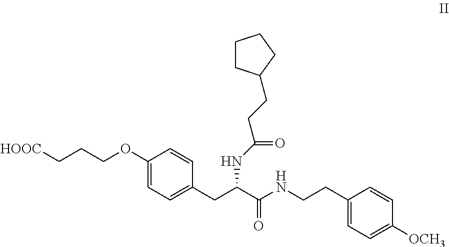

### (S)-4-(4-(2-(3-cyclopentylpropanamido)-3-(4-methoxyphenethylamino)-3-oxopropyl)phenoxy)butanoic acid

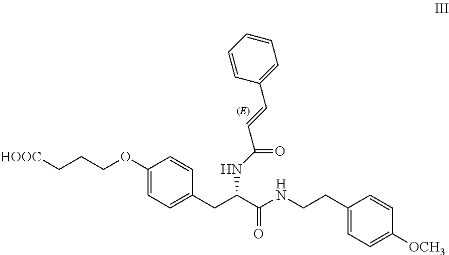

### (S)-4-(4-(2-(3-phenylpropenamido)-3-(4-methoxyphenethylamino)-3-oxopropyl)phenoxy)butanoic acid

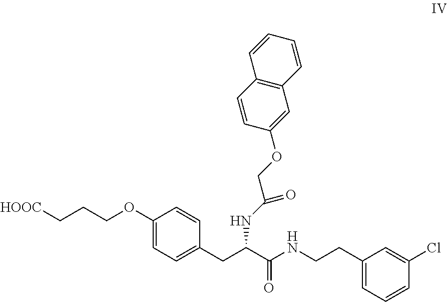

### (S)-4-(4-(3-(3-chlorophenethylamino)-3-oxo-2-(2-(oxo-naphyl)propanamido)propyl)phenoxy)butanoic acid

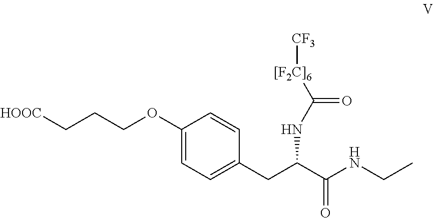

### (S)-4-(4-(3-(ethylamino)-3-oxo-2-(2,2,3,3,4,4,5,5,6,6,7,7,8,8,8-pentadecafluorooctanamido)propyl)phenoxy)butanoic acid

Useful amines for amine capture units for microbial removal include primary amines, secondary amines, tertiary amines, protonated amines, and quaternary ammonium moieties. Examples of suitable amines include alkyl amines, alkyl diamines, heteroalkyl amines, aryl amines, heteroaryl amines, aryl alkyl amines, pyridines, heterocyclic amines (saturated or unsaturated, having a nitrogen in the ring or not), amidines, hydrazines, and the like. Alkyl amines generally have 1 to 12 carbons, e.g., 1-8 carbons, and rings can have 3-12 carbons, e.g., 3-8 carbons. Suitable heterocyclic or alkyl heterocyclic amines include, for example, structure A9. Any of the amines can be employed as a quaternary ammonium compound. Additional suitable quaternary ammonium moieties include trimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

Polyamines includes an amine containing repeating units of a secondary amine (—NH) with alternating units of a C₂₋₁₀ alkylene group. Both the nitrogen and the carbons of the polyamine can be modified or substituted. A preferred polyamine is according to the structure:

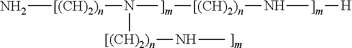

wherein each n is independently 2 to 10 and each m is independently 2 to 2000; or

NH₂—[(CH)₂)ₙ—NH—]ₘ—H

wherein each n is independently 2 to 10 and each m is independently 1 to 8. Suitable polyamines include triethylene tetramine and tetraethylene pentamine or mixtures thereof, as well as polyethylene imines of varying molecular weight. In some embodiments, the polyamine is a polyethylene imine having a number average molecular weight of between about 250 g/mol and 100,000 g/mol, or about 500 g/mol and 25,000 g/mol, or about 500 g/mol and 5,000 g/mol, or about 500 g/mol and 2000 g/mol.

In embodiments, the polyamines are crosslinked to form higher molecular weight compounds. Examples of suitable crosslinking agents for reacting with polyamines include multifunctional carboxylic acids, multifunctional acrylates, multifunctional esters, halohydrins, multifunctional halides, multifunctional isocyanates, and transition metals like zinc. In some embodiments, polyamine crosslinkers are selected from the group of dicarboxylic acids and anhydrides including oxalic acid, malonic acid, maleic acid, maleic anhydride, succinic acid, succinic anhydride, sodium formate, and poly (ethylene glycol) diglycidyl ethers. The optimal concentration of the crosslinking agent is adjusted depending on the reactivity of the crosslinking agent and polyamine as well as the amount of molecular weight increase desired. Inorganic crosslinkers include aluminates, silica acid alkali salt, silica and/or alumino-silicates. In some embodiments, the polyamine is tetraethylene pentamine. In some such embodiments, the crosslinking agent is succinic acid. In some embodiments, the useful range of crosslinking agent is about 0.1 mole % to 40 mole % of a difunctional crosslinking agent, based on moles of amine functionality of the polyamine; or in some embodiments about 1 mole % to 30 mole %, or about 2 mole % to 25 mole %, or about 4 mole % to 20 mole % of a difunctional crosslinking agent, based on moles of amine functionality of the polyamine. In some embodiments, the crosslinking agent is an aluminate compound of the formula Mₙ[H₂ₙ₊₂ AlₙO₃ₙ₊₁], in which M is potassium or sodium and n is a whole number between 1 and 10.

In some embodiments, the filter media of the invention is a nonwoven fabric or mat formed from filter media constituents that are fibers or that include fibers. In some such embodiments, the fibers include the support groups and functional groups, wherein the functional groups are reacted to include the capture agents (capture units) substantially as described above. In such embodiments, the fibers are functionalized with capture agents in the quantities shown in Table 3, expressed as loading amounts of capture agent based on weight of filter media constituent (that is, the fibers themselves) or total surface area of the formed filter media (that is, the nonwoven fabric formed from the fibers). In some embodiments, the capture agents are amine capture agents, as is described above.

TABLE 3

| | Loading amount of capture agent on: | | | | | |
|---|---|---|---|---|---|---|
| Organic | fiber, | fiber, | fiber, | fabric, | fabric, | fabric, |
| Pendant groups | mg/g | mg/g | mg/g | mg/cm² | mg/cm² | mg/cm² |
| Capture agent | 0.01-80 | 0.05-40 | 0.08-20 | 0.01-80 | 0.05-40 | 0.08-20 |
| Amine/ | 0.01-80 | 0.05-40 | 0.08-20 | 0.01-80 | 0.05-40 | 0.08-20 |
| polyamine | | | | | | |

In some embodiments, the invention includes methods and/or devices for binding and removing a ligand from a mobile fluid contacting the filter media of the invention having one or more capture agents bonded thereto. In some such embodiments, a micro-biocidal or static growth result is achieved employing the methods of the invention. In some embodiments the present capture agent is specific for a targeted ligand; in other embodiments the capture agent is broad spectrum for inclusive capture of G+, G− bacteria, fungi and viri.

For example, filter media or filter media constituent bearing a capture agent on its surface can be contacted with a fluid including or suspected of including at least one ligand. Binding of one or more of the ligands to the capture agents is obtained in this way. We have found that the filter media of the invention is capable of at least 5%, for example greater than 10%, 25%, 50%, or even greater than 80% or up to 99.99% binding of the ligand(s). In some embodiments, the surface of the filter media or a filter media constituent bears a single capture agent for a single ligand; in other embodiments, the surface of a filter media or a filter media constituent bears a plurality of capture agents for a plurality of ligands.

In some embodiments, the invention includes a method for binding and removing an organism such as a bacterial organism, fungal organism, biological ligand, biological protein (prions), organism surface molecule, virus or other harmful cell from a fluid. In embodiments, the method includes selecting a capture agent that binds the infective unit from an array of capture agents, reacting the capture agent in a manner that causes the capture agent to be bound to the surface of a filter media or filter media constituent, contacting the capture agent with a fluid having one or more microorganisms within the fluid, and binding the microorganism to the capture agent such that the microorganism remains within the filter media and the fluid passes through the filter media.

### Infectious Agents Removed by the Filter Media

Any of a variety of different types of organisms, microorganisms or microbes may generally be bound and removed from a mobile fluid by contacting the mobile fluid with the filter media of the invention. Target organisms include pathogens and non-pathogens including bacteria, fungi, viruses, mold, yeast, and toxins thereof, etc. In various embodiments, bacteria of a variety of different shapes, cell arrangements, and compositions are captured. Most bacteria, for instance, have one of five basic cell shapes, i.e., (1) round or cocci, (2) rod or bacilli, (3) spiral or spirilli, (4) comma or vibrios, and (5) filaments. Likewise, examples of possible cell arrangements include diplococci (e.g., pair), streptococci (e.g., chain), and staphylococci (e.g., bunched). Diplococci, for example, are known to cause pneumonia. Streptococci are often associated with “strep throat.” Staphylococci are familiar to many because of their role in “staph infections” and some types of food poisoning. Bacteria also vary somewhat in size, but generally average about 0.2 microns to about 2 microns diameter (that is, the smallest dimension in e.g. a rod-shaped bacterium). Although bacteria generally contain cell membranes (i.e., walls) made from lipid bi-layers of liposaccharides, the composition of a type of bacteria may be more specifically classified using a stain Gram+ or Gram− (G+ or G−) reaction (a staining method to classify bacteria). For example, G+ bacteria retain crystal violet stain in the presence of alcohol or acetone and include, for instance, the genera Actinomyces, Bacillus, Bifidobacterium, Cellulomonas, Clostridium, Corynebacterium, Micrococcus, Mycobacterium, Nocardia, Staphylococcus, Streptococcus and Streptomyces. Some of the G+ bacteria, notably those of the genera Corynebacterium, Mycobacterium and Nocardia, retain dyes even in the presence of acid. These are known as Acid-Fast bacteria. G-bacteria do not retain crystal violet stain in the presence of alcohol or acetone, and include, for instance, the genera Acetobacter, Agrobacterium, Alcaligenes, Bordetella, Brucella, Campylobacter, Caulobacter, Enterobacter, Erwinia, Escherichia, Helicobacterium, Legionella, Nesseria, Nitrobact, Pasteurelia, Pseudomonas, Rhizobium, Rickettsia, Salmonella, Shigella, Thiobacilus, Veiellonealla, Vibrio, Xanthomonas and Yersinia.

G− cell membranes include lipopolysaccharides as a main component, and additionally include phospholipids, proteins, lipoproteins, and small amounts of peptidoglycans. The lipopolysaccharide component has a core region to which are attached repeating units of polysaccharide moieties or side chains. The chemical composition of these side chains, both with respect to composition and arrangement of the different sugars, determines the nature of the somatic or O antigen determinants. Such determinants, in turn, are useful in serologically classifying many G− species. For example, some types of G− bacteria that belong to quite different species and have strong serological cross-reactivity, nevertheless possess chemically similar carbohydrate moieties as part of their lipopolysaccharide side chains, which generally have about 30 repeating units. The cell membranes of G+ bacteria include peptidoglycans, polysaccharides, and/or teichoic acids. The peptidoglycans (also called “murein”) are heteropolymers of glycan strands and are cross-linked through short peptides. The bases of the murein are chains of alternating residues of N-acetylglucosamine and N-acetyl muramic acid, which are β-1,4-linked. These chains are cross-linked by short polypeptide chains containing both L- and D-amino acids

Despite sharing common features, the arrangement and composition of the surfaces of G+ and G− bacteria nevertheless differ. For example, G− bacteria have an outer membrane coated with lipopolysaccharide (LPS). The LPS lends a net-negative charge to the surface of G− bacteria and contributes to its pathogenesis. G+ bacteria, on the other hand, are coated with thick peptidoglycan (or murein) sheet-like layers. The sheets are formed from alternating N-acetylglucosamine and N-acetylmuramic acid molecules. Teichoic acids are also found in G+ bacteria and may be linked to the N-acetylmuramic acid. While G− bacteria also have peptidoglycan, the layer on G+ bacteria is much thicker. The peptidoglycan layer of G− bacteria is also located underneath the LPS layer, making it less accessible from the surface.

In addition to bacteria, other microbes of interest include molds and yeasts (e.g., Candida albicans), which belong to the Fungi kingdom. Zygomycota, for example, is a class of fungi that includes black bread mold and other molds that exhibit a symbiotic relationship with plants and animals. These molds are capable of fusing and forming tough “zygospores.” Ascomycota is another class of fungi, which includes yeasts, powdery mildews, black and blue-green molds, and some species that cause diseases such as Dutch elm disease, apple scab, and ergot. The life cycle of these fungi combines both sexual and asexual reproduction, and the hyphae are subdivided into porous walls that allow for passage of the nuclei and cytoplasm. Deuteromycota is another class of fungi that includes a miscellaneous collection of fungi that do not fit easily into the aforementioned classes or the Basidiomycota class (which includes most mushrooms, pore fungi, and puffball fungi). Deuteromycetes include the species that create cheese and penicillin, but also includes disease-causing members such as those that lead to athlete's foot and ringworm.

Organisms that cause common human diseases include viruses associated with common cold, the flu, chickenpox and cold sores. Serious diseases such as Ebola and AIDS are also caused by viruses. Many viruses cause little or no disease and are said to be “benign”. The more harmful viruses are described as virulent. Viruses cause different diseases depending on the types of cell that they infect. Some viruses can cause life-long or chronic infections where the viruses continue to reproduce in the body despite the host's defense mechanisms. This is common in hepatitis B virus and hepatitis C viral infections. People chronically infected with a virus are known as carriers. They serve as important reservoirs of the virus. If there is a high proportion of a carrier in a given population, a disease is said to be endemic.

There are many ways in which viruses spread from host to host but each species of virus uses only one or two. Many viruses that infect plants are carried by organisms; such organisms are called vectors. Some viruses that infect animals and humans are also spread by vectors, usually blood-sucking insects. However, direct animal-to-animal, person-to-person or animal-to-person transmission is more common. Some virus infections, (norovirus and rotavirus), are spread by contaminated food and water, hands and communal objects and by intimate contact with another infected person, while others are airborne (influenza virus). Viruses such as HIV, hepatitis B and hepatitis C are often transmitted by human contact or contaminated hypodermic needles. The spreading mechanism for each different kind of virus must be known to treat the correct surface or fluid to stop viral spread and to prevent infections and epidemics.

Microbes of clinical or environmental interest include bacteria, mycoplasma, fungus, rickettsia, or virus. Suitable bacteria or mycoplasma of clinical or environmental interest include Escherichia coli, Vibrio cholerae, Acinetobacter caicoaceticus, Haemophilus influenzae, Actinobacillus actinoides, Haemophilus parahaemolyticus, Actinobacillus lignieresii, Haemophilus parainfluenzae, Actinobacillus suis, Legionella pneumophila, Actinomyces bovis, Leptospira interrogans, Actinomyces israelli, Mima polymorpha, Aeromonas hydrophila, Moraxella lacunata, Arachnia propionica, Burkholderia mallei, Burkholderia pseudomallei, Moraxella osioensis, Arizona hinshawii, Mycobacterium osioensis, Bacillus cereus, Mycobacterium leprae, Bacteroides spp, Mycobacterium spp, Bartonella bacilliformis, Plesiomonas shigelloides, Bordetella bronchiseptica, Proteus spp, Clostridium difficile, Pseudomonas aeruginosa, Clostridium sordellii, Salmonella cholerasuis, Clostridium tetani, Salmonella enteritidis, Corynebacterium diphtheriae, Salmonella typhi, Edwardsiella tarda, Serratia marcescens, Enterobacter aerogenes, Shigella spp, Staphylococcus epidermidis, Francisella novicida, Vibrio parahaemolyticus, Haemophilus ducreyi, Haemophilus gallinarum, Haemophilus haemolyticus, Bacillus anthracis, Mycobacterium bovis, Bordetella pertussis, Mycobacterium tuberculosis, Borrella burgdorfii, Mycoplasma pneumoniae, Borrella spp, Neisseria gonorrhoeae, Campylobacter, Neisseria meningitides, Chlamydia psittaci, Nocardia asteroids, Chlamydia trachomatis, Nocardia brasillensis, Clostridium botulinum, Pasteurella haemolytica, Clostridium chauvoei, Pasteurelia multocida, Clostridium haemolyticus, Pasteurella pneumotropica, Clostridium histolyticum, Pseudomonas pseudomallei, Clostridium novyl, Staphylococcus aureus, Clostridium perfringens, Streptobacillus moniliformis, Clostridium septicum, Cyclospora cayatanensis, Streptococcus agalacetiae, Erysipelothrix insidiosa, Streptococcus pneumoniae, Klebsiella pneumoniae, Streptococcus pyogenes, Listeria manocytogenes, Yersinia pestis, Yersinia pseudotuberculosis, Yersinia enterocolitica, Brucella abortus, Brucella canis, Brucella melitensis, Brucella suis, and Francisella tularensis.

Fungi of clinical or environmental interest include Absidia, Piedraia hortae, Aspergillus, Prototheca, Candida, Paecilomyces, Cryptococcus neoformans, Cryptosporidium parvum, Phialaphora, Dermatophilus congolensis, Rhizopus, Epidermophyton, Scopulariopsis, Exophiala, Sporothrix schenkii, Fusarium, Trichophyton, Madurella mycetomi, Toxoplasma, Trichosporon, Microsporum, Microsporidia, Wangiella dermatitidis, Mucor, Blastomyces dermatitidis, Giardia lamblia, Entamoeba histolytica, Coccidioides immitis, and Histoplasma capsulatum.

Rickettsia or viruses of clinical or environmental interest include Coronaviruses, Hepatitis viruses, Hepatitis A virus, Myxo-Paramyxoviruses (Influenza viruses, Measles virus, Mumps virus, Newcastle disease virus), Picornavirus (Coxsackie viruses, Echoviruses, Poliomyelitis virus), Rickettsia akari, Rochalimaea Quintana, Rochalimaea vinsonii, Norwalk Agent, Adenoviruses, Arenaviruses (Lymphocytic choriomenigitis, Viscerotrophic strains), Herpesvirus Group (Herpesvirus hominis, Cytomegalovirus, Epstein-Barr virus, Caliciviruses, Pseudo-rabies virus, Varicella virus), Human Immunodeficiency Virus, Parainfluenza viruses (Respiratory syncytial virus, Subsclerosing panencephalitis virus), Picornaviruses (Poliomyelitis virus), Poxviruses Variola, Cowpox virus (Molluscum contagiosum virus, Monkeypox virus, Orf virus, Paravaccinia virus, Tanapox virus, Vaccinia virus, Yabapox virus), Papovaviruses (SV 40 virus, B-K-virus), Spongiform Encephalopathy Viruses (Creutzfeld-Jacob agent, Kuru agent, BSE), Rhabdoviruses (Rabies virus), Tobaviruses (Rubella virus), Coxiella burnetii, Rickettsia canada, Rickettsia prowazekii, Rickettsia rickettsii, Rickettsia Tsutsugamushi, Rickettsia typhi (R. mooseri), Spotted Fever Group Agents, Vesicular Stomatis Virus (VSV), and Toga, Arena (e.g., LCM, Junin, Lassa, Marchupo, Guanarito, etc.), Bunya (e.g., hantavirus, Rift Valley Fever, etc.), Flaviruses (Dengue), and Filoviruses (e.g., Ebola, Marburg, etc.) of all types, Nipah virus, viral encephalitis agents, LaCrosse, Kyasanur Forest virus, Yellow fever, and West Nile virus.

Microbes of clinical or environmental interest include Variola Viruses, Congo-Crimean hemorrhagic fever, Tick-borne encephalitis virus complex (Absettarov, Hanzalova, Hypr, Kumlinge, Kyasanur Forest disease, Omsk hemorrhagic fever, and Russian Spring-Summer Encephalitis), Marburg, Ebola, Junin, Lassa, Machupo, Herpesvirus simiae, Bluetongue, Louping III, Rift Valley fever (Zing a), Wesselsbron, Foot and Mouth Disease, Newcastle Disease, African Swine Fever, Vesicular exanthema, Swine vesicular disease, Rinderpest, African horse sickness, Avian influenza, and Sheep pox. Other components of interest include Ricinus communis.

A capture agent includes combination of building blocks immobilized (e.g., reversibly) on a filter media or filter media constituent via a support group or an amine present on the surface of the media or media constituents. For example, an individual capture agent can be a heterogeneous building block on the surface of a fiber, wherein the fiber is part of a filter media. The building blocks can be immobilized through any of a variety of interactions, such as covalent, electrostatic, or hydrophobic interactions. For example, the building block and support group can each include one or more functional groups or moieties that can form covalent, electrostatic, hydrogen bonding, van der Waals, or like interactions.

In some embodiments, capture agents are in the form of a single amine or a single capture agent or a combination of amine(s) and other types of capture agent(s). In some embodiments, an array of capture agents includes building blocks of general Formula 2 (shown hereinabove), with RE₁ being B1, B2, B3, B3a, B4, B5, B6, B7, B8, or B9 (shown hereinabove) and with RE₁ being A1, A2, A3, A3a, A4, A5, A6, A7, A8, or A9 (shown hereinabove).

In some embodiments, the filter media or filter media constituents of the invention include a plurality of building blocks coupled to a support group. In some such embodiments, the plurality of building blocks include or are building blocks of Formula 2 (shown hereinabove). In a representative example, an abbreviation for the building block including a linker, a tether, a tyrosine group and removal units AxBy is tether-TyrAxBy. In some embodiments, a candidate capture agent can include combinations of building blocks of formula tether-TyrA1B1, tether-TyrA2B2, tether-TyrA2B4, tether-TyrA2B6, tether-TyrA2B8, tether-TyrA3B3, tether-TyrA4B2, tether-TyrA4B4, tether-TyrA4B6, tether-TyrA4B8, tether-TyrA5B5, tether-TyrA6B2, tether-TyrA6B4, tether-TyrA6B6, tether-TyrA6B8, tether-TyrA7B7, tether-TyrA8B2, tether-TyrA8B4, tether-TyrA8B6, or tether-TyrA8B8.

The present invention includes filter media, filter media constituents, and methods of using the filter media to remove an infective agent, or organism, from a mobile fluid that is passed through the filter media. The filter media include one or more capture agents. In some embodiments, the capture agents are loaded at about 0.01 mg/g to 250 mg/g of filter media, or about 0.1 mg/g to 100 mg/g of filter media, or about 1 mg/g to 10 mg/g of filter media. In some such embodiments, the capture agent-loaded filter media are capable of capturing about 5% to 99.999% of the organisms present in the fluid passing through the filter media, or about 10% to 99.99% of the organisms present in the mobile fluid that is passed through the filter media, or about 25% to 99.9% of the organisms present in the mobile fluid that is passed through the filter media. In embodiments, the filter media of the invention result in at least a 2 log reduction in organisms present in the fluid that is passed through the filter media, or at least a 3 log reduction, or at least a 4 log reduction, or at least a 5 log reduction, or even as much as a 6 log reduction, 7 log reduction, or greater reduction in the number of organisms present in the mobile fluid that is passed through the filter media of the invention.

### Filter Media and Filter Media Constituents

The filter media of the invention are employed in the filtration of mobile fluids. For the purposes of this disclosure, filtration describes the process by which undesirable organisms are removed from a mobile fluid, wherein the mobile fluid contacts the filter media and the biological constituents are adsorbed onto the filter media of the invention by one or more capture agents bound to the filter media. The filter media of the invention are employed to carry out such filtration in one or more methods of the invention. In some embodiments, the filter media of the invention also effect mechanical filtration, that is, the sieve-type separation of solids (that in some embodiments include one or more organisms) from one or more fluids; however, it will be understood that it is not necessary aspect of the one or more methods of the invention.

The present invention relates to a filter media having functionality that can trap, immobilize, adsorb or absorb a microbial organism onto or into the media from a mobile fluid. This functionality is called a capture agent. In some embodiments, one or more filter media constituents, that is, one or more materials employed in the fabrication of the filter media of the invention, is provided wherein one or more capture agents are bound thereto. In other embodiments, the filter media is formed and then the capture agents are bound to the filter media after media formation. The capture agents are capable of capturing one or more organisms from a mobile fluid when the capture agent contacts the one or more organisms.

A filter media constituent is, in various embodiments, a fiber, a particle, a bead, a film, or a combination of one or more thereof. In some embodiments, the constituent itself is formed having the capture agent bonded thereto. In other embodiments, the capture agent is added to the constituent and bonded thereto after the constituent itself is substantially formed; then one or more filter media constituents are used to form a filter media of the invention. In still other embodiments, the filter media itself is formed from the one or more filter media constituents prior to the addition of the capture agent, and the capture agent is bonded directly to the constituents of the filter media after media formation. It will be appreciated that the mode of bonding the capture agent to the filter media of the invention will depend on manufacturing efficiency, suitability of a particular bonding technique given the chemical nature of the media constituent, and the like.

Filter media of the invention are typically, though not always, employed in a filter construction. The filter constructions of the invention include one or more filter media and one or more mechanical means of securing the filter media, one or more means of directing a flow of fluid through the filter media, or both. Typical mechanical means of securing and/or directing fluid flow include frames, cartridge housings, columns, scrims, netting, porous membranes, and the like. In some embodiments, the filter constructions include additional filter media that is intended to carry out mechanical filtration only. Multiple filtration media of the invention, for example having different porosities, different filter media constituents or constituent blends, different capture agents bound thereto, and the like are included in some filter construction embodiments.

In embodiments, the filter media constituent is a fiber. In some embodiments the fiber is a combination of one or more fibers of one or more types. Typical fiber types include cellulosic or synthetic polymeric fibers. In embodiments of this invention, the term fiber includes a linear structure having a diameter that can range from about 0.01 microns to as much as 500 microns but typically ranges from about 0.2 to about 50 microns typically in a length substantially in excess of the fiber diameter. In some embodiments the fibers are made in indeterminate lengths and are later processed to form shorter lengths that can be used in the manufacture of fiber collections, or woven or nonwoven fiber fabrics. In some embodiments the fibers are functionalized by binding one or more capture agents thereto.

In some embodiment, the filter media is a collection of fibers, wherein the collection of fibers is a woven or nonwoven fabric. Fabric thickness can be from 0.01 mm to 100 mm or more. Fiber masses can be in an amount of about 1 gm to 5 kG and can take any form including that of any surface, column or container thereof.

The filter media of the invention that are suitably formed from fibers include both woven or nonwoven fabrics. In some embodiments fiber formation is carried out in the same operation as fabric formation; in many such embodiments this is true where the filter media is a nonwoven fabric. In embodiments the fabrics further incorporate one or more additional filter media constituents, such as particles or beads. In various embodiments the fibers, particles, and/or beads have one or more capture agents bound thereto. Nonwoven fiber technology incorporating the polymer compositions of the disclosure provide a cost-efficient way to create a broad range of products that can filter and absorb very precisely.

Table 4 lists several common methods for nonwoven web manufacture and typical or approximate fiber diameters provided by or employed by these methods. It is generally recognized that as the fiber diameter selected decreases in size the surface area of the resulting web proportionately increases with the square of the fiber diameter decrease.

TABLE 4

| | Fiber size (diameter); |
|---|---|
| Method/Fiber Type | bundle size |
| Electrospinning | 10 to 1000 nm; |
| | Low fiber bundles |
| Meltblowing | 500 nm to 10 μm; |
| | High fiber bundles |
| Flash spinning | 2-15 μm; |
| | High fiber bundles |
| Spunbonding | 10-35 μm; |
| | Low to medium fiber bundles |
| Bicomponent fibers | 200 nm to 1000 nm |

Spunmelt processes are used in the manufacture of spunbond (SB) nonwovens, and the hybrid meltblown (MB) nonwovens, and combinations of the two, and are made by extruding molten polymer through spinnerets to form fibers. Spunmelt currently dominates in the medical drape and gown market providing a diversified product spectrum from a range of microfibers. In electrospinning, nonwoven fabric of submicron solid fibers are drawn from a viscous polymer (solution or melt) stream delivered through a capillary tube with a high voltage electric field.

SB, MB, flash spinning (FS), and electrostatic spinning (ES) are among the more popular processes for producing microfiber nonwovens. Although these processes are very different from one another, they all share the same character of making a fibrous product from a polymer in one-step.

Fibers produced from a SB technology can have an average fiber diameter, in the upper limit of a microfiber concept of, for example, from about 15 to about 35 microns. Recent development in bicomponent SB, combined with other technology, such as hydro-entanglement, can provide even finer SB fibers.

MB processing can also make microfibers on the micron or sub-micron scale. MB microfibers can be engineered for a broad spectrum of applications, such as medical fabrics, filter media, protective clothes, and absorbent products. The MB process can be exploited in a variety of aspects, including use of specialty polymers, developing unique fiber and web structures, bicomponent, and microfiber composites. In embodiments, the present disclosure provides a filter media including a nonwoven web, the nonwoven web comprises, for example, at least one of: a spunbond fabric, meltblown fabric, and combinations thereof. Combinations of spunbond fabric and meltblown fabric are known and can be, for example, spunbond-meltblown-spunbond (SMS), spunbond-meltblown-meltblown-spunbond (SMMS), and like permutations or combinations. The nonwoven web may also comprise, for example, bonded carded webs (BCW) which is made from, for example, carded staple fibers which are, for example, bonded together in heat fused discreet bonds, chemical bonds in some pattern or chemical bonds at most fiber crossings and the like.

Microfibers are often used in composite structures to balance properties. The composite can be, for example, spunbond/melt blown/spunbond (SMS), where the SB layers serve as the external skeleton to provide the strength and the support, whereas MB layers can contribute, for example, filtration and barrier characteristics. The technology allows the SB and/or MB section to include more than one layer for special applications, such as SMMS, SSMMS, and like structures.

SMS or SMMS fabrics have been widely used in products that require high barrier properties that are critical for applications in such fields as hygienic and medicine. The barrier properties of those materials are highly dependent on the performance of both ‘M’ and ‘S’ layers. In general, the finer the fiber sizes and the higher the weight of the ‘M’ layer, the greater the barrier properties the SMS or SMMS fabrics will possess.

Microfiber nonwoven composites having specialty chemical treatments can provide useful fabrics in the medical field. Combinations of SB and MB microfiber technologies and optionally treatment technologies can be used to further improve or add other functional properties, such as protection and comfort. Filtration applications in the medical field include, for example, facial masks.

Cotton-surfaced nonwovens in which carded bleached cotton/PP staple fiber webs (e.g., 60/40 cotton/PP) or hydro-entangled 100% cotton can be used, for example, to make face masks. The cotton surface of the cotton-surfaced nonwovens is ideally worn against the face for greater comfort. It is beneficial for the cotton surface to retain antimicrobial agents and contain fluorochemical repellents to enhance the ability of the face mask to kill bacteria and virus, and repel water and contaminants.

In embodiments, spunlaced fabrics can be made of combinations of wood pulp and synthetic fiber layered composites. Tissue paper, or unbonded wood pulp fibers can be layered on top of, for example, a carded or spunbond web prior to hydroentanglement. The fabric can have one side that is rich in wood pulp fiber. Additional chemical treatment can be added to the wood pulp fibers to achieve desired barrier properties.

As in the meltblown process, the spunbond system operator can vary the fiber and pore sizes of the web to meet a broad range of containment properties. In addition, spunbond fabric can be manufactured to accommodate required strength characteristics.

Meltblown and spunbond webs can be used together as a composite fabric, providing control over absorption and filtration characteristics, as well as strength. Composite webs comprising combinations of spunbond and meltblown webs can be employed in the filter constructions of the invention.

Meltblown and spunbond nonwoven fiber technology heats and extrudes polymers including, for example, biodegradables, nylon, polyethylene, polyesters, polypropylene, and polyamides through a specialized die onto a forming table to create a web. A system operator can vary the fiber and effective pore size of the meltblown web to accommodate the customer's absorption and filtration specifications.

In addition to the abovementioned monofiber methods and materials, the non-woven webs and fabrics fashioned there from can be comprised of, or include, bi-component fibers. Bi-component (bico or conjugate) technology enables manufacturers to, for example: reduce cost; improve strength and softness; produce ultra-fine fibers; provide improved loft, crimp, or both; and like process and product improvements. Typical bi-component fiber products include, for example, sheath and core, side-by-side, islands-in-the-sea and splittables (also known as segmented pie).

Nanofiber processing can include, for example, electrospinning, where fibers are spun with diameters of from about 10 nm to several hundred nanometers. The resulting fiber properties can depend on, for example, field uniformity, polymer viscosity, electric field strength, the distance between nozzle and collector, and like considerations. The production rate is typically low, such as grams per hour. Another nanofiber processing can include, for example, bi-component fiber spinning techniques which can produce, for example, “Islands-In-The-Sea” fibers, for example, of about 1-3 denier with from about 240 to about 1,120 filaments surrounded by a dissolvable polymer. Dissolving the outer “sea” polymer leaves a matrix of nanofibers, which can be further separated by stretching or mechanical agitation. The polymer ratio is generally 80% islands (nanofilaments) and 20% sea. The nanofilaments, resulting after dissolving the sea polymer component, have a diameter of, for example, about 300 mn. Compared to electrospinning, nanofibers produced with this technique can have a very narrow but coarser diameter range.

Web production methods useful for fiber and fabric preparation can include any other suitable method, such as spunlace, porous film, co-form, bonded-carded, needle punch, airlaid, wetlaid, airlaid, and like methods, or combinations thereof. Spunlace processing, also known as hydroentangling, involves mechanically wrapping and knotting fibers in a web through the use of high velocity jets of water. Spunlaced nonwovens work well for wipes because they are soft, strong, and easy to handle, and provide good absorption.

Wetlaid nonwoven formation typically involves the use of a Fourdrinier type papermaking apparatus, where aqueous slurries of fibers are dispensed onto a moving wire, wherein the fibers are captured by the wire and the liquid—typically water—is allowed to drain through the wire, optionally aided by application of vacuum suction beneath the wire. Such operations are particularly useful to make thin layers of nonwoven filter media, and are further easily adapted to include particles, beads, and the like. Additionally, since the fibers are not formed—e.g. from the thermoplastic—as the nonwoven web is formed, a large variety of fiber types are usefully employed to form the filter media of the invention. Wood pulp or other cellulosic fibers, for example, are suitably employed, as are glass fibers.

Airlaid nonwoven formation, like wetlaid, does not involve fiber formation concomitant with nonwoven web formation. In airlaid nonwoven formation, air carries the fibers rather than a liquid. Airlaid nonwovens are typically very soft, bulky, and porous, that is, they have high loft and low density compared to wetlaid nonwovens.

In embodiments, methods useful for fiber and fabric preparation can additionally include any other suitable processing methods, for example, thermo-bonding, chemical or resin bonding, and like methods. In embodiments, methods useful for fiber and fabric preparation can additionally include other suitable functional or performance additives or treatments, for example, an antimicrobial, an anti-stat, a flame retardant, a fluorochemical, a wetting agent, an ultraviolet stabilizer, a lamination, a binder or an adhesive, a melt adhesive, and like additives or treatments, or combinations thereof. In embodiments, depending upon its disposition and purpose in the fiber or final article, an additive can be included, for example, in a masterbatch, added directly to an extruder, applied topically to a fiber or web surface, and like inclusion methods, or combinations thereof. In embodiments, a binder or an adhesive can include, for example, an acrylic, a hot melt, a latex, a polyvinyl chloride, a pressure sensitive adhesive, a styrenated acrylic, styrene butadiene, vinyl acetate, ethylene vinyl acetate, vinyl acrylic, a melt-fusible fiber, a partially meltable bicomponent fiber (e.g., PE/PP, PE/PET, specially formulated PET/PET), and like materials, or combinations thereof. In embodiments, the filter media is post treated, for example to impart electrostatic properties (“electrets”).

In embodiments, the filter media constituent is a particle. A particle is a discrete solid body having at least one dimension ranging between 1 nm and 1 mm. In some embodiments particles are formed from clusters of smaller particles, forming a porous mass. For the purposes of this disclosure, particle composition is not particularly limited. Commonly employed particles in mechanical filtration applications include those formed from silica such as colloidal silica, fumed silica, modified fumed silica, diatomaceous earth, or sand; metals in powder or colloidal form such as aluminum, copper, titanium, tungsten, and the like; carbon such as activated charcoal; metal oxides such as titanium dioxide, aluminum oxide, and the like. The particles are, in various embodiments, spherical, elongated, rodlike, or irregularly shaped. The particles vary in size in some embodiments, while in other embodiments the particles are of substantially uniform size.

In some embodiments, the particle is substantially non-porous, that is, the mobile fluid and organisms therein that are contacted with the filter media formed employing such particles do not substantially penetrate the interior of the particle. In such embodiments, the surface of the non-porous particle is functionalized with one or more capture agents. In other embodiments, the particle is a porous particle. Porous particles are, in some embodiments, functionalized with capture agents on the surface of the particle. Additionally or alternatively, porous particles are, in some embodiments, functionalized with capture agents in the interior of the particle where the fluid contacts the interior surfaces. Such interior functionalization, where present, increases the effective surface area for filtration and capture. In some embodiments, the porous particle enhances physical filtration by the filter media including the particle.

In embodiments, the filter media constituent is a bead. A bead is a discrete solid body having at least one dimension ranging between about 100 nm and 100 mm. In embodiments, beads are supplied in mesh sizes, for example between about 10 and 1000 mesh. In some embodiments, the bead is substantially non-porous, that is, wherein the fluid and organisms passed through a filter media formed therefrom do not substantially penetrate the interior of the bead. In other embodiments, the bead is a porous bead.

Beads are formed from any of the materials listed above employed in particles. Further, beads are formed in various embodiments by dividing and crosslinking at least the surface of a synthetic or naturally arising polymer particle. For example, size exclusion chromatography beads are formed from e.g. polystyrene, agarose (obtained from seaweed), and the like. In some embodiments, the crosslinked beads are functionalized with moieties for ion exchange, hydrophobic interaction, affinity, or desalting of water or another liquid. In some embodiments, the beads are swollen with the mobile fluid, a liquid, prior to forming the filter media or filter construction; in this way, “pores” are formed within the bead. The degree of crosslinking and the solvent employed to swell the beads determines the size of the pores. In embodiments, crosslinked beads are between about 0.1% and 20% crosslinked, for example between about 0.1% to 0.5% crosslinked, about 0.5% to 1.0% crosslinked, about 1% to 2% crosslinked, about 2% to 5% crosslinked, about 5% to 10% crosslinked, or about 10% to 20% crosslinked.

In embodiments, the filter media constituent is a film. The film is generally a thermoplastic polymer formed into a macroscopically flexible, semi-rigid, or rigid planar structure. Any of the known polymers employed in film formation, which are widely known and understood by those of skill in the art, are suitably employed herein as films as that term is employed in this disclosure. Films are generally between 1 micrometer and 1 centimeter thick, for example between about 10 microns and 2 millimeters thick, or between about 25 micrometers and 1 millimeter thick; however, the thickness of the film is not particularly limited by the applications thereof as filter media constituents of the invention.

In some embodiments, the film is porous. In some such embodiments, porous films are formed by incorporating e.g. a particulate solid or phase separating liquid into the film during film formation, then stretching the film by uniaxial or biaxial tentering after film formation to cause holes to open up within the thickness of the film where phase separation causes localized strain-induced loss of cohesion between the film composition and the particulate solid or phase-separating liquid. In some such embodiments, the particulate solid or phase separating liquid is functionalized with one or more capturing agents. In other embodiments, the film itself is functionalized with one or more capturing agents, either before or after film formation and/or stretching. In some embodiments, the film is a membrane, that is, a thin film that constitutes essentially a single filtering layer. In other embodiments, the film has multiple effective filtering layers. In some embodiments, the film or membrane is a filter constituent; in other embodiments, the film or membrane is the filter media itself.

In some embodiments, the film is a microstructured film. A microstructured film has one or two major surfaces that are planar and further bear one or more surface structures formed thereon. For example, in embodiments, flow channels are defined on the surface of a planar thermoplastic film. The structured surface can have a series of divided and discrete microstructures formed thereon, or in some embodiments have a series of channels, that is, ribs formed thereon. The microstructures have, in various embodiments, average heights ranging from 100 micrometers to about 5 millimeters, and average widths ranging from about 200 micrometers to about 50 mm, wherein the average aspect ratio ranges from about 0.5 to 10. Microstructured films are suitably made using profile extrusion to form ribs, optionally stretching and/or slicing the ribs after extrusion, or other thermal molding techniques such as nip roll embossing or hot press embossing.

The filter media constituents are suitably employed, either alone or in combination with other filter media constituents, to form the filter media of the invention. The other filter media constituents are, in various embodiments, any of the filter media constituents described herein, or other constituents such as conventional filter media constituents as those materials are widely known in the filtration industry.

In embodiments, the filter media is a structured stacked filtration array having a series of flow channels. The array is typically formed from a microstructured thermoplastic film, wherein a series of two or more such microstructured surfaces are arranged to form a stacked array. The microstructures are arranged, from layer to layer, in a manner that creates a suitable flow pattern of a fluid passing therethrough. Such filtration media are described, for example, in U.S. Pat. No. 6,589,317; any of the microstructured arrays disclosed therein, as well as variations on these microstructured arrays, are suitably employed as filter media of the invention when one or more capture agents is bound thereto.

In various embodiments where any of the filter media discussed above are formed, filter media formation includes one or more additional suitable functional or performance additives or treatments, for example, anti-static, flame retardant, fluorochemical, wetting agent, ultraviolet stabilizer, lamination, binder or adhesive, melt adhesive, and like additives or treatments, or combinations thereof are all useful depending on the type of filtration envisioned. In embodiments, the filter media is post treated, for example to impart electrostatic properties (“electrets”); such treatments are suitably employed for some methods of air filtration, or other gaseous filtration applications.

### Filter Constructions, Filters, and Applications

In some embodiments, the filter constructions of the invention include a support article (support) and one or more filter media of the invention. In other embodiments, filter constructions are formed entirely of the filter media without additional support articles. In embodiments, the support is a cartridge, column, housing, frame, sintered glass plate, scrim, netting, perforated metal plate, or other article or combination of such articles. The support surrounds, houses, or supports the filter media of the invention in a manner that allows the filter media to function under the intended conditions while in use. In some embodiments, the support includes one or more features that guide the fluid through the filter media.

For example, a cartridge design often includes a space for the filter media, an inlet for introducing the fluid into the cartridge at a first end of the cartridge, and an outlet for dispensing the filtered fluid from the cartridge at a second end, such that the fluid is cause to traverse the entire length of the cartridge. The cartridge also serves to hold the filter media, for example beads or particles, in a pack that in turn facilitates the filtration operation itself. In another example, a simple frame surrounding a flat piece of nonwoven filter media fabric holds the filter media in place. In some such embodiments, the frame further cooperates with an external inlet-outlet system to form a seal, for example in an air intake filter for an engine, to prevent air from bypassing the filter. In some embodiments, the support is a simple strip of metal, for example in a face mask that includes such a metal strip intended to conform and hold the mask tightly across the bridge of a person's nose.

In some embodiments, two or more filter media are employed in a filter construction. For example, a filter cartridge employs, in embodiments, a layer or series of layers of nonwoven filter media encasing a cake of particles or beads, topped by a second layer or series of layers of a nonwoven filter media that is the same or different from the first layer or series of layers. In this manner, the particle cake or beads are kept secured within the cartridge housing and is prevented from eluting from the outlet along with a liquid or gas passing through the cartridge. A filter construction includes one or more filter media of the invention and is not particularly limited as the thickness of media employed or any other dimension; it will be appreciated by those of skill that the filter construction is designed to meet the requirements of the intended end use.

In embodiments, the filter construction is intended to be used in conjunction with passive filtration operations, such as in a hazardous materials (haz-mat) suit that encloses a person. In other embodiments, the filter construction is intended to be used in conjunction with gravity-mediated filtration, such as simple column elution of e.g. water. In still other embodiments, the filter construction is intended for use under positive pressure, such as forced air filtration (e.g. furnace filters, cabin air filters, and the like) or water filtration (pool water or tap water filtration). It will be appreciated that the loading of capture agent on a filter media of the invention, the type and loading of a filter media of the invention in a filter construction, and the overall construction features of the filter constructions of the invention, will be optimized by one of skill depending on the application end use envisioned; for example, a pressurized flow of water bearing a heavy loading of organisms will typically require lower pressure drop filter media but a higher amount of capture agent loading within the filter media when compared to the requirements of the filter media when the application is a gravity-mediated flow of water, e.g. through a column, bearing a relatively low level of organisms. It will be appreciated that the filter media and filter constructions of the invention are easily optimized for various envisioned end uses.

In some embodiments, the filter constructions or filter media of the invention are suitably employed in a filter. A filter is an article that employs either the filter media itself or a filter construction and is characterized in that it includes the basic infrastructure necessary to carry out a filtration process. In embodiments, the filter includes one or more apparatuses for directing a mobile fluid through the filter media. In some such embodiments, the one or more apparatuses include one or more walls, cylinders, columns, pipes, metal plates, metal strips, clamps, elastic bands, mechanical fasteners, conduits, o-rings, seals, inlets, outlets, flow gauges, flow regulators, pumps, fans, sources of mobile fluid, or combinations thereof. For example, in a representative embodiment, the circular disc of a nonwoven filter media of the invention is enclosed in a ring-like frame, along with a circular, perforated metal plate on one major side of the filter media, to form a filter construction. The filter construction is then placed in the bottom of a cylindrical column having an inlet at the top of the column and an outlet at the bottom of the column, with the perforated metal plate facing the bottom of the column. The column and the filter media with the ring-like frame and circular, perforated metal plate disposed inside is a filter. In the column example provided, the column having. In such an embodiment, the filter is capable of carrying out filtration of a fluid passing through the column, whereas the filter construction, being essentially a disc in a frame, is not because the fluid is not suitably directed through the filter media but for its presence in the column. Using the filter of the example embodiments, gravity filtration of water, forced air filtration, etc. are possible depending on the type and amount of filter media employed in the filter. Many other embodiments are readily envisioned by one having skill. In some embodiments, the filter construction is replaceable in the filter. In some embodiments, the filter media is useful in a filter without having the support of the filter construction. In some embodiments, a filter construction is a filter; for example, a column can be both a support for a simple filter media and, together with the filter media, the filter itself.

The filter media of the invention are suitably conformed to a variety of shapes and layered conformations in conjunction with the envisioned end use application and the desired filter construction. For example, air filter constructions employ, in some embodiments, fluted or pleated filter media formed from nonwoven fibers, optionally including particulates entrained in the nonwoven fabric. Other filter constructions include nonwoven filter media wrapped, for example between 2 and 500 wraps, around a perforated cylinder. Nonwoven filter media are also suitably cut and shaped into disks, sheets, and the like for conformation within a housing, cartridge, tube, and the like. Varying dimensions of the filter media within a filter construction and within a filter are possible and easily designed for specific applications. For example, in some embodiments a thin single layer of filter media, for example 0.01 mm thick, is employed to meet the filtration requirements, including organism capture, of the intended filtration application. In other embodiments, 1 meter or more of filter media thickness is required to meet the filtration requirements, including organism capture, of the intended filtration application. Other suitable dimensions for specific applications are easily envisioned by one having skill.

Suitable fluids filtered with the filter media and filter constructions of the invention include any fluids bearing an undesirable content of organisms, wherein removal of the organisms from the fluid is desirable. Any gas or liquid is suitably filtered employing the filter media and filter constructions of the invention; however, in many embodiments, air or water are the fluids requiring such treatment.

Air filter constructions are useful in the home or like household or lodging environments, including hotels, inns, hospitals, furnished rental property, elder care housing, a dormitory, a restaurant, a dining hall, and like residential or institutional settings; or to a cabin air filter that filter air provided to the interior cabin of e.g. an automobile, airplane, or boat cabin or other interior and enclosed space. Representative nonlimiting air filtration applications include cabin air filtration, HVAC filtration, clean room filtration, haz-mat suits for filtering out biological hazards, facial mask air filtration for surgical or other medical applications, vacuum cleaner filter bags, and the like. Representative water filtration applications include drinking water filtration such as tap water spigot filtration systems, tap water pitcher filtration systems, and reverse osmosis systems; whole-house water filtration systems; pool water filtration; sewage treatment; syringe filters for aqueous matrices; and filters for bodily fluids, e.g. in conjunction with dialysis, blood transfusion, and the like. Other fluid filtration applications include, for example, oil filters and fuel filters for gas powered or electrically powered engines and other mechanisms or for purification of such fluids prior to end use.

Applications of the filter media and filter constructions of the invention are found in various industries including, for example, automotive, aerospace, hospital-medical, biotechnology such as biologics isolation and purification, industrial materials processing, food or beverage processing, water treatment, such as sea water remediation, sewage treatment, drinking water remediation and purification and like industries, oil filtration, fuel filtration, air filtration, bodily fluid filtration such as for blood dialysis, aircraft cabin filtration, medical filtration such as hospital breathing mask filtration, and filtration articles such as a diafiltration membrane, an osmosis membrane, reverse osmosis membrane, an ultra-filter, a micro-filter, a dialysis membrane, a gas-mask filter, a pilot's mask filter, a workman &/or surgery and the like face mask filter, a vacuum cleaner filter, a bag house filter, an ozone filter, a clean room filter, a fuel filter, an oil filter, a drinking water purification filter, and like applications.

### Experimental Section

### General Procedures

### Organisms and Cultures

1. Test Organisms—Names & ATCC Numbers:
a. Staphylococcus auerus, ATCC 6538
b. Escherichia coli, ATCC 25922
c. Salmonella enterica serovar Typhimirium, ATCC 14020
d. Klebsiella pneumoniae ssp pneumoniae, ATCC 27736

2. Culture Media
a. BHI broth—used for initial enrichment of Culti-Loop lyophilized stocks
b. TS broth/agar—stock culture maintenance, testing stocks, plate counting for Staph aureus
c. LB broth/agar—stock culture maintenance, testing stocks, plate counting for E. colit, Salmonella, Klebsiella

3. Plate Counting
a. Used to quantitatively evaluate performance of filter materials

### Filter Media Preparation

1. Nonwoven Filter Media
a. All filter media fabrics were obtained from the Sutherland Felt Company of Madison Heights, Mich.
b. LD fabric: 8 oz. white polyester nonwoven, ⅛″ (0.32 cm) thick
c. HD fabric: 11 oz. white polyester nonwoven, 1/16″ (0.16 cm) thick
d. UHD fabric: 18 oz white polyester nonwoven, ⅛″ (0.32 cm) thick
e. All filter media fabrics were used as is except where “unmodified” control fabric was employed in a bacteria capturing example. In the control examples, the fabric was washed 3× with 25% methanol in water.

2. Functionalization of the Filter Fabrics

a. Amines
All amine reagents were obtained from Sigma Aldrich Company of St. Louis, Mo. Amine treatment solutions were formed as follows. Tetraethylene pentamine or a 90/10 v/v mixture of tetraethylene pentamine and polyethylene imine (Mn 1,200, Mw 1,300) was dissolved in water at 50% v/v. Alternatively (Example 9 only), tetraethylene pentamine in 95% ethanol/0.1N NaHCO₃ (1/1 (v/v)) was mixed with succinyl chloride (20 mol % based on tetraethylene pentamine).
The filter fabric was saturated, and the fibers fully coated, with the amine treatment solution at laboratory temperature. The saturated fabric was placed in a 60W microwave oven and subjected to between 3 and 9 microwave heating cycles as follows: 60s microwave on “high”, 60s off, 60s microwave on “high”, 120s off. The fabric was subjected to multiple washes using 25% aqueous methanol, followed by air drying.
Ninhydrin based amine analysis of the materials gave amine (both primary and secondary) loads of up to 100 nanomoles of available (i.e. primary or secondary) amine per milligram of nonwoven material (dry weight).

b. Capture Agent
Compound I, (S)-4-(4-(3-(3-chlorophenethylamino)-3-oxo-2-(3-(pyridin-3-yl)propanamido)propyl)phenoxy)butanoic acid (Compound I) was synthesized as described in J. Am. Chem. Soc., 2009, 131 (46), pp 16660-16662. Compound I was dissolved in an 80/20 v/v solution of DMF/H₂O at 40 μmol/mL of aqueous DMF. Then sulfo-N-hydroxysuccinimide (SNHS) and 1-ethyl-3-(3-dimethylaminopropyl)carbodiimide (EDAC) was added to the aqueous DMF solution to form a reaction solution having a molar ratio of 1.6 SNHS:1.1 EDAC:1.0 Compound I. Then an amine modified fabric, as described in section a. above, was immersed in the reaction solution in an amount corresponding to 2 molar equivalents of Compound I per mole of available amine, wherein available amine was calculated in section a. above. The fabric was agitated in the reaction solution overnight (about 16 hours) at laboratory temperature, followed by washing with aqueous ethanol solution and drying to give the filter media modified with Compound I.
Ninhydrin amine analysis of the fabric treated in this manner showed significant loss of both primary and secondary amine functionality when compared to the amine treated fabric (section a.), indicating that Compound I was covalently attached to amine moieties present on the fiber surface. The concentration of Compound I bonded to the amine functionality present on the fiber surface was greater than 25 mol %, usually greater than 40 mol %, and often greater than about 60 mol % of available amines as analyzed prior to the reaction with Compound I.

### Examples 1-5

The treated filter media indicated in Table 5 was sampled by cutting 6 mm diameter discs from each treated sheet. The bacterial stocks were diluted 1:10,000 in sterile H₂O to create testing stock, then 50 μl of the testing stock was pipetted directly onto each disc. The discs were allowed to sit for about 1 minute, then the disc was placed in a 2 mL microcentrifuge tube along with 1 mL of sterile H₂O. The tube was mixed on an orbital shaker for 5 minutes at 120 rpm. Then the water from the tube was sampled and plated for counting.

Table 5 is a compilation of multiple experiments evaluating percent removal of the target organism using the column protocol described above. Bacterial loads were 1.0E03-1.2E04 cfu/disc. The table shows that the modified filtration media of the invention are capable of capturing and retaining substantial quantities of microorganisms.

TABLE 5

| Exam- | | | | | |
|---|---|---|---|---|---|
| ple | Filter Fabric, | Test Organism, % removal | | | |
| No. | Fabric Treatment | Staph | E. Coli | Klebsiella | Salmonella |
| 1 | LD, tetraethylene | 57 | 89 | — | — |
| | pentamine | | | | |
| 2 | LD, tetraethylene | 64 | 98 | 83 | 83 |
| | pentamine and | | | | |
| | polyethylene imine | | | | |
| 3 | LD, tetraethylene | 90 | 78 | 99 | 83 |
| | pentamine and | | | | |
| | polyethylene | | | | |
| | imine; Compound I | | | | |
| 4 | HD, tetraethylene | 94 | 100 | 93 | 96 |
| | pentamine and | | | | |
| | polyethylene imine | | | | |
| 5 | HD, tetraethylene | 85 | 98 | — | — |
| | pentamine and | | | | |
| | polyethylene | | | | |
| | imine; Compound I | | | | |

### Examples 6-9

The treated filter media were sampled by cutting 6 mm discs from each treated sheet. The fit was removed from a Handee Spin column (obtained from Thermo Fisher Scientific (Pierce Protein Research Products) of Waltham, Mass.) and replaced with disc of filter media, which was then secured by an O-ring. The column was pre-wetted with 0.5 ml sterile H₂O, and the flow-through was discarded. Bacterial stock was diluted 1:1000 by volume in sterile H₂O to create testing stock. Then 0.5 ml of the testing stock was added to column. The flow-through was collected for plating. Then the column was washed with two washes of sterile H₂O, 0.5 ml each, and these washes were also collected for plating. Controls were an empty column (inoculated and washed as described, wherein the plated out washes indicated that no bacteria were captured by the column), a bacterial control wherein an aliquot of the testing stock was plated out for comparison, and an unmodified filter media (see GENERAL PROCEDURES, Filter Media Preparation, 1.e.) tested in column format, following the same protocol as for the treated filter media.

Percent capture was evaluated by incubating the plates overnight at 37° C., then counting the plates and comparing them to the control plates as described.

Table 6 shows percent removal of Staphylococcus aureus, ATCC 6538, using the protocol described above. Bacterial loads were 1.0E03-1.2E04 cfu/disc. The modified filter media of the invention are capable of capturing and retaining substantial quantities of microorganisms compared to the unmodified starting materials.

TABLE 6

| | | Media Type, % | | |
|---|---|---|---|---|
| Example | Filter Media | removal of Staph | | |
| No. | Treatment | LD | HD | UHD |
| C1 | None (unmodified) | 2 | 14 | 49 |
| 6 | Tetraethylene | 44 | 41 | — |
| | pentamine | | | |
| 7 | Tetraethylene | 58 | 71 | 95 |
| | pentamine and | | | |
| | polyethylene imine | | | |
| 8 | Tetraethylene | 78 | 56 | — |
| | pentamine and | | | |
| | polyethylene imine; | | | |
| | Compound I | | | |
| 9 | Succinic acid- | — | 66 | — |
| | crosslinked | | | |
| | tetraethylene pentamine | | | |

### Examples 10-14

Following the experimental procedures employed for Examples 6-9, multiple experiments evaluating percent removal of various organisms were carried out. Bacterial loads were 1.0-7.5E03 cfu/disc. The results, tabulated in Table 7, show that the modified materials of the invention are capable of capturing and retaining substantial quantities of microorganisms compared to the unmodified starting materials.

TABLE 7

| Example | Filter Fabric, | Test Organism, % removal | | |
|---|---|---|---|---|
| No. | Fabric Treatment | E. Coli | Klebsiella | Salmonella |
| C2 | LD, unmodified | 82 | 42 | 7 |
| 10 | LD, tetraethylene | 92 | 76 | 45 |
| | pentamine and | | | |
| | polyethylene imine | | | |
| 11 | LD, tetraethylene | 56 | 70 | 72 |
| | pentamine and | | | |
| | polyethylene imine; | | | |
| | Compound I | | | |
| 12 | HD, tetraethylene | 91 | 82 | 69 |
| | pentamine and | | | |
| | polyethylene imine | | | |
| 13 | HD, tetraethylene | 85 | — | — |
| | pentamine and | | | |
| | polyethylene imine; | | | |
| | Compound I | | | |
| C3 | UHD, unmodified | <65 | — | — |
| 14 | UHD, tetraethylene | 95 | — | — |
| | pentamine and | | | |
| | polyethylene imine | | | |

The foregoing is applicable to various compositions and articles of the invention disclosure. The following examples and data further exemplify the invention. The invention may be better understood with reference to the following examples. These examples are intended to be representative of specific embodiments of the invention, and are not intended as limiting the scope of the invention. While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention. As used herein, and in the claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

We claim:

1. A filter media capable of removing an amount of a target organism from a mobile fluid, the filter media comprising:
(a) one or more filter media constituents comprising a fiber, a particle, a film, or a bead; and
(b) one or more pendant groups bound to at least one of the filter media constituents, the pendant groups comprising:
(i) one or more removal units capable of binding to a target organism; and
(ii) one or more polyamine groups,
wherein the filter media is capable of capturing a sufficient number of a challenge population of target organisms from the mobile fluid to render the mobile fluid substantially non-infective.

2. The filter media of claim 1 wherein the pendant groups are present in an amount of about 0.01 mg/g to 80 mg/g of the filter media.

3. The filter media of claim 1 wherein the pendant groups are present in an amount of about 0.05 mg/cm² to 5 mg/cm² of filter media.

4. The filter media of claim 1 wherein the polyamine is present in an amount of 0.01 to 80 mg-gm⁻¹ of the filter media.

5. The filter media of claim 1 wherein the filter media is capable of removing at least about 90% of the challenge population of target organisms from the mobile fluid.

6. The filter media of claim 1 wherein the filter media is a nonwoven fabric and the filter media constituents comprise a fiber.

7. The filter media of claim 6 wherein the fiber comprises a melt blown fiber.

8. The filter media of claim 7 wherein the melt blown fiber comprises a polyamide, a polyurethane, a polycarbonate, or a mixture of one or more thereof.

9. The filter media of claim 6 wherein the fiber comprises a synthetic polyolefin.

10. The filter media of claim 6 wherein the fiber comprises a cellulosic fiber, a synthetic polymeric fiber or a mixed cellulosic and synthetic polymeric fiber.

11. The filter media of claim 6 wherein the fiber comprises a synthetic polyester.

12. The filter media of claim 1 wherein the removal unit comprises a derivative of a compound having structure I, II, III, IV, V, or mixtures thereof:

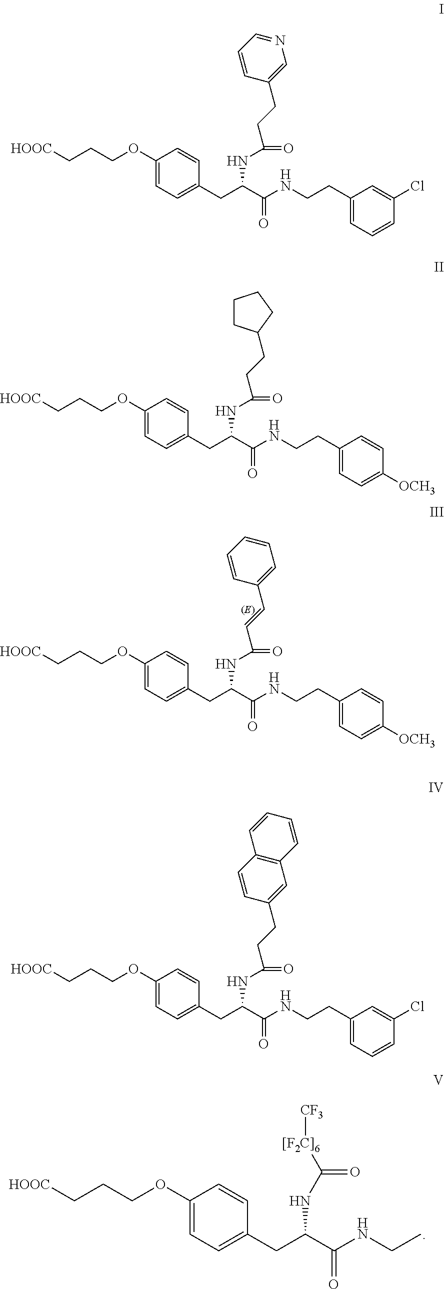

13. The filter media of claim 1 wherein the polyamine comprises a compound of the formula NH₂—[(CH)₂)ₙ—NH—]ₘ—H, wherein n is 2 to 4 and m is 1 to 4.

14. The filter media of claim 13 wherein the polyamine has a number average molecular weight of between about 500 g/mol and 2000 g/mol.

15. The filter media of claim 1 wherein the polyamine comprises tetraethylene pentamine.

16. The filter media of claim 1 wherein the challenge population comprises a G+ or G− bacterium, a fungus, a virus, or a prion.

17. The filter media of claim 16 wherein the challenge population comprises staphlococcus, coliform, campylobacter, salmonella or lysteria bacteria or mixtures thereof.

18. The filter media of claim 16 wherein the challenge population comprises MRSA.

19. The filter media of claim 16 wherein the challenge population comprises HIV, a herpes virus, rhinovirus or combinations thereof.

20. The filter media of claim 1 wherein the mobile fluid comprises water.

21. The filter media of claim 1 wherein the mobile fluid comprises air.

22. A filter construction comprising:
(a) a filter media according to claim 1, and
(b) one or more supports.

23. The filter construction of claim 22 wherein the one or more supports comprise one or more cartridges, frames, columns, scrims, screens, perforated metal plates, perforated metal cylinders, or combinations thereof.

24. A filter comprising
(a) the filter media of claim 1; and
(b) an apparatus for causing a mobile fluid to flow through the filter media.

25. The filter of claim 24 wherein the apparatus for directing a mobile fluid through the filter media comprises one or more walls, cylinders, columns, pipes, metal plates, metal strips, clamps, elastic bands, mechanical fasteners, conduits, o-rings, seals, inlets, outlets, flow gauges, flow regulators, pumps, fans, sources of mobile fluid, or combinations thereof.

26. The filter of claim 24, wherein the filter further comprises one or more supports comprising one or more cartridges, frames, columns, scrims, screens, perforated metal plates, perforated metal cylinders, or combinations thereof.

27. The filter of claim 24, wherein the filter functions as an HVAC filter, a clean room air supply filter, a haz-mat suit, a medical facial mask, a vacuum cleaner bag filter, a baghouse filter, a tap water filter, a reverse osmosis filter, a pool water filter, a dialysis filter, a blood transfusion filter, a syringe filter, a sewage treatment filter, an oil filter, or a fuel filter.

28. A filter media capable of removing an amount of a target organism from a mobile fluid, the filter media comprising:
(a) a nonwoven fabric comprising polyester, polyamide, or cellulosic fiber; and
(b) one or more pendant groups bonded to the fiber, the pendant groups comprising a derivative of a compound having structure I, II, III, IV, V, or mixtures of two or more thereof: 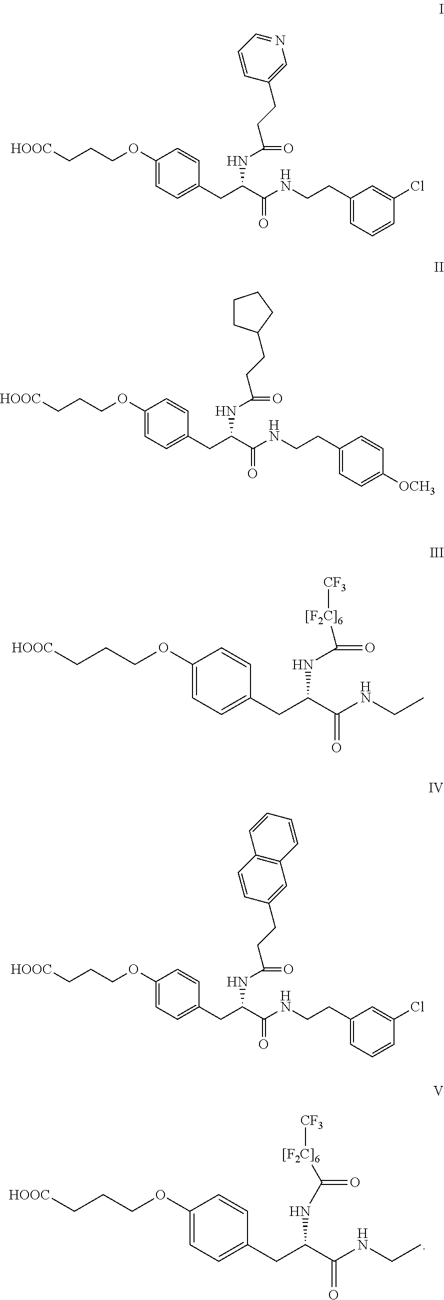
wherein the filter media is capable of removing at least about 90% of a challenge population of target organism from the mobile fluid.

29. The filter media of claim 28 wherein the fiber further comprises polyamine, the polyamine comprising a compound of the formula NH₂—[(CH)₂)₂—NH—]ₘ—H, wherein n is 2 to 4 and m is 1 to 4.

30. The filter media of claim 28 wherein the mobile fluid comprises water.

31. The filter media of claim 28 wherein the mobile fluid comprises air.

32. A filter construction comprising:
(a) a filter media according to claim 28, and
(b) one or more supports.

33. The filter construction of claim 32 wherein the one or more supports comprise one or more cartridges, frames, columns, scrims, screens, perforated metal plates, perforated metal cylinders, or combinations thereof.

34. A filter comprising
(a) the filter media of claim 28; and
(b) an apparatus for directing a mobile fluid through the filter media.

35. The filter of claim 34 wherein the apparatus for directing a mobile fluid through the filter media comprises one or more walls, cylinders, columns, pipes, metal plates, metal strips, clamps, elastic bands, mechanical fasteners, conduits, o-rings, seals, inlets, outlets, flow gauges, flow regulators, pumps, fans, sources of mobile fluid, or combinations thereof.

36. The filter of claim 34, wherein the filter further comprises one or more supports comprising one or more cartridges, frames, columns, scrims, screens, perforated metal plates, perforated metal cylinders, or combinations thereof.

37. The filter of claim 34, wherein the filter functions as an HVAC filter, a clean room air supply filter, a haz-mat suit, a medical facial mask, a vacuum cleaner bag filter, a baghouse filter, a tap water filter, a reverse osmosis filter, a pool water filter, a dialysis filter, a blood transfusion filter, a syringe filter, a sewage treatment filter, an oil filter, or a fuel filter.

38. A filter media capable of removing an amount of a target organism from a mobile fluid, the filter media comprising:
(a) a nonwoven fabric comprising fiber; and
(b) one or more polyamine groups bonded the fiber, the polyamine group having the structure NH₂—[(CH)₂)ₙ—NH—]ₘ—H, wherein n is 2 to 4 and m is 1 to 4;
the polyamine being present on the fiber in an amount of 0.05 to 80 mg/cm² of the filter media, wherein the filter media is capable of removing at least about 90% of a challenge population of target organism from the mobile fluid.

39. The filter media of claim 38 wherein the mobile fluid comprises water.

40. The filter media of claim 38 wherein the mobile fluid comprises air.

41. A filter construction comprising:
(a) a filter media according to claim 38, and
(b) one or more supports.

42. The filter construction of claim 41 wherein the one or more supports comprise one or more cartridges, frames, columns, scrims, screens, perforated metal plates, perforated metal cylinders, or combinations thereof.

43. A filter comprising
(a) the filter media of claim 38; and
(b) an apparatus for directing a mobile fluid through the filter media.

44. The filter of claim 43 wherein the apparatus for directing a mobile fluid through the filter media comprises one or more walls, cylinders, columns, pipes, metal plates, metal strips, clamps, elastic bands, mechanical fasteners, conduits, o-rings, seals, inlets, outlets, flow gauges, flow regulators, pumps, fans, sources of mobile fluid, or combinations thereof.

45. The filter of claim 43, wherein the filter further comprises one or more supports comprising one or more cartridges, frames, columns, scrims, screens, perforated metal plates, perforated metal cylinders, or combinations thereof.

46. The filter of claim 43, wherein the filter functions as an HVAC filter, a clean room air supply filter, a haz-mat suit, a medical facial mask, a vacuum cleaner bag filter, a baghouse filter, a tap water filter, a reverse osmosis filter, a pool water filter, a dialysis filter, a blood transfusion filter, a syringe filter, a sewage treatment filter, an oil filter, or a fuel filter.

47. A method of removing a challenge population of target organisms from a mobile fluid, the method comprising:
(a) contacting the mobile fluid with a filter media, the filter media comprising:
one or more filter media constituents comprising a fiber, a particle, a film, or a bead; and
(ii) one or more pendant groups bound to at least one of the filter media constituents, the pendant groups comprising one or more removal units capable of binding to a target organism and one or more polyamine groups; and
(b) capturing a sufficient number of target organisms from the mobile fluid to render the mobile fluid substantially non-infective.

48. The method of claim 47 wherein at least about 90% of the target organisms are captured.

49. The method of claim 47 wherein the capturing comprises a 2 log to 7 log reduction of target organisms in the mobile fluid.

50. The method of claim 47 wherein the mobile fluid comprises air and the contacting is carried out under positive pressure.

51. The method of claim 47 wherein the mobile fluid comprises water.

52. The method of claim 51 wherein the contacting is carried out under positive pressure.

53. The method of claim 51 wherein the mobile fluid is tap water, salt water, sea water, sewage, industrial wastewater, a bodily fluid, rainwater, or effluent.

54. The method of claim 51 wherein the pH of the mobile fluid is 5 to 9.

55. The method of claim 47 wherein the mobile fluid is an oil or a fuel.
